(19) United States
(12) Patent Application Publication
(10) Pub. No.: US 2012/0212696 A1
(43) Pub. Date: Aug. 23, 2012

(54) VARIABLE OPTICAL ELEMENT COMPRISING A LIQUID CRYSTAL ALIGNMENT LAYER

(75) Inventors: Anita Trajkovska, Christiansburg, VA (US); Ronald Blum, Roanoke, VA (US); Joshua Haddock, Roanoke, VA (US); William Kokonaski, Gig Harbor, WA (US)

(73) Assignee: PixelOptics, Inc., Roanoke, VA (US)

(21) Appl. No.: 13/359,252

(22) Filed: Jan. 26, 2012

Related U.S. Application Data
(60) Provisional application No. 61/437,703, filed on Jan. 31, 2011.
(60) Provisional application No. 61/437,702, filed on Jan. 31, 2011.
(60) Provisional application No. 61/436,647, filed on Jan. 27, 2011.
(60) Provisional application No. 61/436,644, filed on Jan. 27, 2011.

(51) Int. Cl. G02F 1/1337

(52) U.S. Cl. 349/123

(57) ABSTRACT

In some embodiments, a first optical device may be provided. The first optical device may include a first substrate, a liquid crystal alignment layer comprising a controlled pattern of features each having a dimension of at most 2 microns, and a liquid crystal layer disposed adjacent to the alignment layer that includes liquid crystal molecules.

### CROSS-REFERENCES TO RELATED APPLICATIONS

This application claims benefit under 35 U.S.C. §119(e) of U.S. provisional patent application No. 61/436,644, filed on Jan. 27, 2011; U.S. provisional patent application No. 61/436,647, filed on Jan. 27, 2011; U.S. provisional patent application No. 61/437,702, filed on Jan. 31, 2011; and U.S. provisional patent application No. 61/437,703, filed on Jan. 31, 2011. The entire disclosure of each of these applications is incorporated herein by reference for all purposes and in their entireties.

### BACKGROUND OF THE INVENTION

Currently, there are numerous electro-optical devices containing a liquid crystal (LC) layer that undergo changes in its optical characteristics under externally applied electrical fields. For successful operation and performance of these LC-based devices, the LC material should generally be appropriately aligned (i.e. the LC molecules contained within the LC material). Visual changes (i.e. optical changes) occur nearly exclusively due to different orientations of LC molecules in different states of device operation (e.g. the device has different optical properties in the “ON”-state, the “OFF”-state, and potentially many states in-between). Depending on the operation mode of the LC device, one can generally distinguish the so-called field-free orientation (e.g. the “OFF-state”) and a range of predetermined distributions over the LC orientations under an applied voltage (e.g. the “ON-state”). The field-free LC orientation is generally provided by the boundary conditions of a geometry confining the LC layer, which boundary conditions are dictated by the alignment layer(s). The alignment layer is usually coated on the inner side of both substrates, which comprise the LC layer (i.e. the substrates that border the LC layer). The basis for the molecular orientation of the LC layer is the physical and/or chemical anisotropy on the surface of an alignment film resulting in an anisotropic arrangement of the adjacent LC molecules.

### BRIEF SUMMARY OF THE INVENTION

Embodiments disclosed herein may comprise devices, and methods for fabricating devices, that may include a liquid crystal alignment layer having a structure that creates variable optical properties in a liquid crystal layer. For example, the alignment layer may comprise a topographical structure and/or physical features (in addition to any other characteristics of the alignment layer and the liquid crystal layer) that may vary the pre-tilt angle of the liquid crystal molecules of the a liquid crystal layer. In general, the alignment layer may have any structure and any characteristics so as to provide a desired variation of the pre-tilt angle of the liquid crystal molecules across the liquid crystal layer.

The variation of the pre-tilt angle of the liquid crystal molecules may vary the index of refraction of portions of the liquid crystal layer. The variation in the refractive index may be used to create an optical power profile for the liquid crystal layer. In this manner, the liquid crystal layer may provide a desired optical property, such as, by way of example, providing additional plus or minus optical power, reducing distortion created by other optical components, and/or creating continuous optical power profiled across portions of the lens.

Some embodiments may comprise a device that is electro-active (i.e. having a liquid crystal layer that has optical properties that may change based on the application of an electric field across the layer). In some embodiments, the liquid crystal layer may provide a first optical power in an inactive state, and a second optical power in an active state. However, embodiments are not so limited, and in some embodiments the liquid crystal layer may comprise reactive mesogens that may be frozen into a particular configuration. The inventors have found that embodiments may be used in many optical applications, including ophthalmic lenses. For instance, devices that may comprise exemplary alignment layers may include, by way of example only, contact lenses, intraocular lenses, semi-finished or finished lens blanks, eyeglasses, or any other suitable optical device.

In some embodiments, a first optical device may be provided. The first optical device may include a first substrate, a liquid crystal alignment layer having a controlled pattern of features each having a dimension of at most 2 microns, and a liquid crystal layer disposed adjacent to the alignment layer that includes liquid crystal molecules. In some embodiments, the liquid crystal alignment layer may be a variable liquid crystal alignment layer.

In some embodiments, in the first optical device as described above, the liquid crystal layer may be electro-active. In some embodiments, in the first optical device as described above, the liquid crystal layer may comprise reactive mesogens.

In some embodiments, in the first optical device as described above, the alignment layer may vary a pre-tilt angle of the liquid crystal molecules of the liquid crystal layer continuously by at least approximately 5 degrees over a distance of approximately 1 mm. In some embodiments, the alignment layer may continuously vary the pre-tilt angle of the liquid crystal molecules over a distance of at least approximately 2 mm of the liquid crystal layer. In some embodiments, the alignment layer may continuously vary the pre-tilt angle of the liquid crystal molecules over a distance of at least approximately 5 mm of the liquid crystal layer. In some embodiments, the alignment layer may continuously vary the pre-tilt angle of the liquid crystal molecules over a distance of at least approximately 10 mm of the liquid crystal layer. In some embodiments, the alignment layer may continuously vary the pre-tilt angle of the liquid crystal layer so as to form a progressive addition lens.

In some embodiments, in the first optical device as described above, the alignment layer may vary a pre-tilt angle of the liquid crystal molecules of the liquid crystal layer discretely by at least approximately 10 degrees over a distance of approximately 1 mm. In some embodiments, the alignment layer may vary the pre-tilt angle of the liquid crystal molecules of the liquid crystal layer discretely by at least approximately 10 degrees multiple times over a distance of approximately 1 mm. In some embodiments, the alignment layer may discretely vary the pre-tilt angle of the liquid crystal molecules at least twice over a distance of approximately 1 mm of the liquid crystal layer.

In some embodiments, in the first optical device as described above, the alignment layer may vary the pre-tilt angle of the liquid crystal molecules of the liquid crystal layer by at least approximately 10 degrees. In some embodiments, the alignment layer may vary the pre-tilt angle of the liquid crystal molecules of the liquid crystal layer by at least approximately 20 degrees. In some embodiments, the alignment layer may vary the pre-tilt angle of the liquid crystal molecules of the liquid crystal layer by at least approximately 45 degrees. In some embodiments, the alignment layer may vary the pre-tilt angle of the liquid crystal molecules of the liquid crystal layer by approximately 90 degrees.

In some embodiments, in the first optical device as described above, the liquid crystal layer may have a refractive index profile, where the refractive index profile may vary at least in part based on the alignment layer. In some embodiments, the refractive index profile of the liquid crystal layer may vary by at least approximately 0.2. In some embodiments, the refractive index profile of the liquid crystal layer may vary by at least approximately 0.5. In some embodiments, the refractive index profile of the liquid crystal layer may vary by at least approximately 1.0. In some embodiments, the refractive index profile may vary continuously for at least a portion of the liquid crystal layer. In some embodiments, the refractive index profile may vary discretely for at least a portion of the liquid crystal layer.

In some embodiments, in the first optical device as described above, the liquid crystal layer may have a first optical power profile when a field (e.g. an electric field) is not applied across the liquid crystal layer, where the first optical power profile varies at least in part based on the alignment layer. In some embodiments, the first optical power profile of the liquid crystal layer may vary by at least approximately 0.2 diopters. In some embodiments, the first optical power profile of the liquid crystal layer may vary by at least approximately 0.5 diopters. In some embodiments, the first optical power profile of the liquid crystal layer may vary by at least approximately 1.0 diopter. In some embodiments, the first optical power profile of the liquid crystal layer may vary by at least approximately 1.5 diopters. In some embodiments, the first optical power profile of the liquid crystal layer may vary between approximately 0.25 to 4.0 diopters.

In some embodiments, in the first optical device as described above where the liquid crystal layer has a first optical power profile when a field (e.g. an electric field) is not applied across the liquid crystal layer, the optical power profile may vary continuously for at least a portion of the liquid crystal layer. In some embodiments, the first optical power profile may vary discretely for at least a portion of the liquid crystal layer.

In some embodiments, in the first optical device as described above, the liquid crystal layer may comprise nematic, smectic, or cholesteric liquid crystals.

In some embodiments, in the first optical device as described above, the alignment layer may comprise polyimide, polyvinyl alcohol, polyacrylate, polymethacrylate, polyurethane or epoxy material.

In some embodiments, in the first optical device as described above, the alignment layer may include a plurality of topographical features, where each topographical feature may have an approximate geometric center. The approximate geometric center of each topographical feature may be located at a distance d₂ from the center of an adjacent topographical feature. In some embodiments, the distance d₂ between each adjacent topographical feature is approximately the same. In some embodiments, the distance d₂ between each adjacent topographical feature may vary across the alignment layer. In some embodiments, the distance d₂ between the approximate geographic centers of each adjacent topographical feature may be between approximately 10 and 200 nm. In some embodiments, the first substrate has an approximate geometric center and the distance d₂ between the approximate geographic centers of each adjacent topographical feature is smaller for topographical features that are disposed closer to the center of the first substrate.

In some embodiments, in the first optical device as described above, the alignment layer may comprise a plurality of topographical features. In some embodiments, each topographical feature of the alignment layer may have a height d₃, where the height d₃ of each of the topographical features may be approximately the same.

In some embodiments, in the first optical device as described above, the alignment layer may comprise a plurality of topographical features. In some embodiments, each topographical feature has a height d₃, where the height d₃ of the topographical features may vary across the liquid crystal layer. In some embodiments, the height d₃ of each topographical feature may be between approximately 10 and 200 nm.

In some embodiments, in the first optical device as described above, the liquid crystal layer may be disposed over an entire surface of the first substrate. In some embodiments, in the first device as described above, the liquid crystal layer may be disposed over a portion of a surface of the first substrate.

In some embodiments, in the first optical device as described above, the alignment layer may be disposed over an entire surface of the first substrate. In some embodiments, in the first device as described above, the alignment layer may be disposed over a portion of a surface of the first substrate.

In some embodiments, in the first optical device as described above, the first optical device may comprise a semi-finished or finished lens blank.

In some embodiments, in the first optical device as described above, the first optical device may further include a second substrate and a first electrode and a second electrode that may be disposed between the first substrate and the second substrate. The alignment layer and the liquid crystal layer may be disposed between the first electrode and the second electrode. In some embodiments, the liquid crystal layer may be electro-active. In some embodiments, the first optical device may further include a second liquid crystal alignment layer comprising a controlled pattern of features having a dimension of at most approximately 2 microns. The second liquid crystal alignment layer may comprise a variable liquid crystal alignment layer. In some embodiments, the second alignment layer may be disposed on a surface of the second substrate. In some embodiments, the second alignment layer may be disposed between the first electrode and the second electrode.

In some embodiments, in the first optical device as described above, the optical device may include a first optical zone. The first optical zone may be in optical communication with a first portion of the alignment layer, a first portion of the liquid crystal layer, and a first portion of the first substrate. The first optical zone may have an optical power that comprises the optical power provided by the first portions of the alignment layer, the liquid crystal layer, and the first substrate.

In some embodiments, the optical power of the first portion of the liquid crystal layer when an electric field is not applied may comprise a progressive optical power. In some embodiments, where the optical power of the first portion of the liquid crystal layer when an electric field is not applied comprises a progressive optical power, the progressive optical power may provide a full add power of at least 0.5 D. In some embodiments, where the optical power of the first portion of the liquid crystal layer when an electric field is not applied comprises a progressive optical power, the progressive optical power may provide a full add power of at least 1.0 D. In some embodiments, where the optical power of the first portion of the liquid crystal layer when an electric field is not applied comprises a progressive optical power, the progressive optical power may provide a full add power of at least 1.5 D.

In some embodiments, in first optical device as described above where the optical power of the first portion of the liquid crystal layer when an electric field is not applied comprises a progressive optical power, the optical power of the first portion of the first substrate is a negative optical power.

In some embodiments, in the first optical device as described above, the first optical device may further include a progressive addition surface. In some embodiments, the progressive addition surface may be disposed on the first substrate. In some embodiments, the progressive addition surface creates an unwanted astigmatism and a portion of the liquid crystal layer may have an optical power such that the unwanted astigmatism is at least partially reduced when a field is not applied across the liquid crystal layer.

In some embodiments, the portion of the liquid crystal layer may have an optical power such that the unwanted astigmatism is reduced by at least approximately 30% when a field is not applied across the liquid crystal layer. In some embodiments, the portion of the liquid crystal layer may have an optical power such that the astigmatism is removed when a field is not applied across the portion of liquid crystal layer.

In some embodiments, in the first optical device as described above that includes a progressive addition surface and a portion of the liquid crystal layer that has an optical power such that the unwanted astigmatism is at least partially reduced, the first optical device may include a first optical zone. The progressive addition surface may provide a plus optical power to the first optical zone and the liquid crystal layer may provide plus optical power to the first optical zone when a field is applied to the liquid crystal layer. In some embodiments, the liquid crystal layer may provide at least approximately 0.5 D of plus optical power to the first optical zone when a field is applied to the liquid crystal layer. In some embodiments, the liquid crystal layer may provide at least approximately 1.0 D of plus optical power to the first optical zone when a field is applied to the liquid crystal layer. In some embodiments, the liquid crystal layer may provide at least approximately 1.5 D of plus optical power to the first optical zone when a field is applied to the liquid crystal layer.

In some embodiments, in the first optical device as described above that includes a progressive addition surface and a portion of the liquid crystal layer that has an optical power such that the unwanted astigmatism is at least partially reduced, where the progressive addition surface may provide a plus optical power to a first optical zone and where the liquid crystal layer may provide plus optical power to the first optical zone when a field is applied to the liquid crystal layer, the liquid crystal layer mal also provide a minus optical power to the first optical zone when a field is not applied to the liquid crystal layer.

In some embodiments, in the first optical device as described above, the liquid crystal layer may provide a progressive optical power when a field is not applied across the liquid crystal layer and a uniform optical power when a field is applied across the liquid crystal layer.

In some embodiments, in the first optical device as described above, the liquid crystal layer may comprise a substantially uniform material. In some embodiments, in the first optical device as described above, the liquid crystal layer has a thickness that is less than approximately 100 nm. In some embodiments, in the first optical device as described above, the liquid crystal layer may have a thickness that is between approximately 50 nm and 100 nm. In some embodiments, in the first optical device as described above, the first optical device may comprise an ophthalmic lens.

In some embodiments, a first method of may be provided. The first method may include the steps of providing a substrate having a liquid crystal layer that comprises reactive mesogens and controlling an alignment of the reactive mesogens in the liquid crystal layer. The alignment may be controlled by utilizing a liquid crystal alignment layer having a controlled pattern of features. The liquid crystal alignment layer may comprise a variable liquid crystal alignment layer. The features may have a dimension of at most 2 microns. The first method may further include the step of solidifying the reactive mesogens in the alignment.

In some embodiments, in the first method as described above, the step of solidifying the reactive mesogens may comprise UV irradiation. In some embodiments, the UV irradiation may comprise unpolarized UV light having a wavelength between approximately 300 and 400 nm.

In some embodiments, in the first method as described above, the step of controlling the alignment layer may include disposing a second alignment layer adjacent to the liquid crystal layer. In some embodiments, the second alignment layer may comprise a controlled pattern of features each having a dimension of at most 2 microns.

In some embodiments, in the first method as described above, the step of controlling the alignment layer may further include processing the mesogens with a variable UV light beam. In some embodiments, processing the mesogens with a variable UV light beam may comprise varying the UV exposure of the mesogens. In some embodiments, varying the UV exposure may comprise varying the intensity of the UV light beam. In some embodiments, the intensity of the UV light beam may be varied by at least approximately 5%. In some embodiments, the intensity of the UV light beam may be varied by at least approximately 10%. In some embodiments, the intensity of the UV light beam may be varied by at least approximately 30%. In some embodiments, the intensity of the UV light beam may be varied by at least approximately 50%.

In some embodiments, the step of varying the UV exposure of the mesogens may comprise exposing different portions of the liquid crystal layer to the UV beam for different amounts of time. In some embodiments, the amount of time different portions of the liquid crystal layer may vary by at least approximately 10%. In some embodiments, the amount of time different portions of the liquid crystal layer may vary by at least approximately 20%. In some embodiments, the amount of time different portions of the liquid crystal layer may vary by at least approximately 50%.

In some embodiments, in the first method as described above, the liquid crystal layer may have a refractive index profile that is based in part on the alignment layer. In some embodiments, the refractive index profile varies continuously.

In some embodiments, in the first method as described above, the alignment layer may comprise a surface topography; where the refractive index profile may vary based at least in part on the surface topography of the alignment layer.

In some embodiments, in the first method as described above, the liquid crystal layer may be substantially continuous.

In some embodiments, in the first method as described above, the liquid crystal layer may have a thickness that is less than approximately 100 nm. In some embodiments, the liquid crystal layer may have a thickness that is between approximately 50 nm and 100 nm.

### BRIEF DESCRIPTION OF THE DRAWINGS

FIGS. 1(a) and (b) show exemplary optical devices comprising an alignment layer and a liquid crystal (LC) layer in accordance with some embodiments. In particular, FIG. 1(a) shows an exemplary embodiment in which the LC layer covers substantially the entire surface of a lens. FIG. 1(b) shows an exemplary embodiment in which the LC layer covers only a portion of the surface of a lens.

FIGS. 2(a) and (b) show cross sectional views of exemplary optical devices comprising an alignment layer and a liquid crystal (LC) layer in accordance with some embodiments. In particular, FIG. 2(a) shows an exemplary embodiment in which the LC layer covers substantially the entire surface of a lens. FIG. 2(b) shows an exemplary embodiment in which the LC layer covers only a portion of the surface of a lens.

FIG. 3 shows a cross sectional view of an exemplary embodiment of an optical device comprising an alignment layer and a LC layer having LC molecules that have a pre-tilt angle that varies in accordance with some embodiments.

FIGS. 4(a)-(h) show exemplary embodiments of alignment layers having controlled patterned of features of surface topographies in accordance with some embodiments.

FIGS. 5(a)-(c) show exemplary embodiments of LC molecules having variable pre-tilt angles based at least in part on the topographical features of the exemplary alignment layers in accordance with some embodiments.

FIGS. 6(a) and (b) show exemplary optical devices that may comprise LC layers having reactive mesogens in accordance with some embodiments.

FIGS. 7(a)-(c) show exemplary pre-tilt alignments of LC molecules in accordance with some embodiments.

FIG. 8 show an exemplary polymerization process of reactive mesogens using UV-light and/or heat in accordance with some embodiments.

FIG. 9 shows an exemplary process using variable intensity UV light to orient the pre-tilt angle of reactive mesogens in accordance with some embodiments.

FIG. 10 shows a cross sectional view of an exemplary optical device that comprises two LC layers and one alignment layer in accordance with some embodiments.

FIGS. 11(a)-(c) show exemplary optical power profiles for exemplary lenses comprising a LC layer having a variable optical power profile in accordance with some embodiments. FIG. 11(d) shows a graphical representation of the optical power profiles shown in FIG. 11(c) in accordance with some embodiments.

FIGS. 12(a) and (b) shown exemplary optical power profiles for optical devices that may comprise a LC layer having a variable optical power profile in accordance with some embodiments.

FIGS. 13(a)-(i) show graphs of exemplary refractive index profile of LC layers in accordance with some embodiments.

FIG. 14 shows a cross sectional view of an exemplary optical device comprising a liquid crystal layer disposed between two alignment layers in accordance with some embodiments.

FIG. 15(a) is an image of an experimental alignment layer comprising a plurality of nano-grooves made with a FIB-method. FIG. 15(b) is a focused view of the experimental alignment layer shown in FIG. 15(a).

### DETAILED DESCRIPTION

Some terms that are used herein are described in further detail as follows:

As used herein, “add power” may refer to the optical power added to the far distance viewing optical power which is required for clear near distance viewing in a multifocal lens. For example, if an individual has a far distance viewing prescription of −3.00 D with a +2.00 D add power for near distance viewing then the actual optical power for near distance is −1.00 D. Add power may sometimes be referred to as plus power. Add power may be further distinguished by referring to “near viewing distance add power,” which refers to the add power in the near viewing distance portion of the optic and “intermediate viewing distance add power” may refer to the add power in the intermediate viewing distance portion of the optic. Typically, the intermediate viewing distance add power may be approximately 50% of the near viewing distance add power. Thus, in the example above, the individual would have +1.00 D add power for intermediate distance viewing and the actual total optical power in the intermediate viewing distance portion of the optic is −2.00 D.

As used herein, the term “alignment layer” may refer to a layer of material that controls the alignment of liquid crystals in the absence of an external field and often adheres to the surface of a substrate (such as an electrode, a lens, lens blank, lens wafer, etc.). As used herein, a “nano-stuctured alignment layer” may refer to an alignment layer that comprises topographical features (such as bumps, grooves, mounds, ridges, etc.) that have a dimension that is less than 2 μm.

As used herein, the term “approximately” may refer to plus or minus 10 percent, inclusive. Thus, the phrase “approximately 10 mm” may be understood to mean from 9 mm to 11 mm, inclusive.

As used herein, the term “comprising” is not intended to be limiting, but may be a transitional term synonymous with “including,” “containing,” or “characterized by.” The term “comprising” may thereby be inclusive or open-ended and does not exclude additional, unrecited elements or method steps. For instance, in describing a method, “comprising” indicates that the claim is open-ended and allows for additional steps. In describing a device, “comprising” may mean that a named element(s) may be essential for an embodiment, but other elements may be added and still form a construct within the scope of a claim. In contrast, the transitional phrase “consisting of” excludes any element, step, or ingredient not specified in a claim.

As used herein, a “dynamic lens” may refer to a lens with an optical power which is alterable with the application of electrical energy, mechanical energy or force. Either the entire lens may have an alterable optical power, or only a portion, region or zone of the lens may have an alterable optical power. The optical power of such a lens is dynamic or tunable such that the optical power can be switched between two or more optical powers. The switching may comprise a discrete change from one optical power to another (such as going from an “off” or inactive state to an “on” or active state) or it may comprise continuous change from a first optical power to a second optical power, such as by varying the amount of electrical energy to a dynamic element (e.g. tunable). One of the optical powers may be that of substantially no optical power. A dynamic lens may also be referred to as a dynamic optic, a dynamic optical element, a dynamic optical zone, dynamic power zone, or a dynamic optical region.

As used herein, a “far viewing distance” may refer to the distance to which one looks, by way of example only, when viewing beyond the edge of one's desk, when driving a car, when looking at a distant mountain, or when watching a movie. This distance is usually, but not always, considered to be approximately 10 feet or greater from the eye. The far viewing distance may also be referred to as a far distance and a far distance point.

As used herein, an “intermediate viewing distance” may refer to the distance to which one looks, by way of example only, when reading a newspaper, when working on a computer, when washing dishes in a sink, or when ironing clothing. This distance is usually, but not always, considered to be between approximately 20 inches and approximately 4 feet from the eye. The intermediate viewing distance may also be referred to as an intermediate distance and an intermediate distance point.

As used herein, the term “layer” does not require a uniform thickness of material. Indeed, a layer may comprise some imperfections or uneven thicknesses so long as the layer performs its intended purpose.

As used herein, a “lens” may refer to any device or portion of a device that causes light to converge or diverge. The device may be static or dynamic. A lens may be refractive or diffractive. A lens may be concave, convex or plano on one or both surfaces. A lens may be spherical, cylindrical, prismatic or a combination thereof. A lens may be made of optical glass, plastic or resin. A lens may also be referred to as an optical element, an optical zone, an optical region, an optical power region or an optic. It should be noted that within the optical industry a lens can be referred to as a lens even if it has zero optical power. Moreover, a lens may refer to both intra-ocular and extra-ocular components.

As used herein, a “lens blank” refer to an optical material that may be shaped into a lens. A lens blank may be finished meaning that the lens blank has been shaped to have an optical power on both external surfaces. A lens blank may be semi-finished meaning that the lens blank has been shaped to have an optical power on only one external surface. A lens blank may be unfinished meaning that the lens blank has not been shaped to have an optical power on either external surface. A surface of an unfinished or semi-finished lens blank may be finished by means of a fabrication process known as free-forming or by more traditional surfacing and polishing.

As used herein, “mesogens” refer to liquid crystals or similar material that possesses long range order and/or a certain degree of positional order. For example, a liquid-crystalline molecule typically consists of a rigid part and one or more flexible parts. The rigid part provides the order, whereas the flexible parts induce fluidity in the liquid crystal. “Reactive mesogens” may refer to mesogens that are photo- and/or thermally-reactive and may have their orientation frozen based on a chemical or physical change, such as through the cross-linking of molecules.

As used herein, a “multi-focal lens” may refer to a lens having more than one focal point or optical power. Such lenses may be static or dynamic. Examples of static multifocal lenses include a bifocal lens, trifocal lens or a Progressive Addition Lens. Examples of dynamic multifocal lenses include electro-active lenses whereby various optical powers may be created in the lens depending on the types of electrodes used, voltages applied to the electrodes and index of refraction altered within a thin layer of liquid crystal. Multifocal lenses may also be a combination of static and dynamic. For example, an electro-active element may be used in optical communication with a static spherical lens, static single vision lens, and static multifocal lens such as, by way of example only, a Progressive Addition Lens.

As used herein, a “near viewing distance” may refer to the distance to which one looks, by way of example only, when reading a book, when threading a needle, or when reading instructions on a pill bottle. This distance is usually, but not always, considered to be between approximately 12 inches and approximately 20 inches from the eye. The near viewing distance may also be referred to as a near distance and a near distance point.

As used herein, an “ophthalmic lens” may refer to a lens suitable far vision correction which includes a spectacle lens, a contact lens, an intra-ocular lens, a corneal in-lay, and a corneal on-lay.

As used herein, “optical communication” may refer to the condition whereby two or more optics of given optical power are aligned in a manner such that light passing through the aligned optics experiences a combined optical power equal to the sum of the optical powers of the individual elements.

As used herein, the “pre-tilt angle” of the liquid crystal molecule refers to the number of degrees that the liquid crystal molecules adjacent to a substrate deviate from the plane of the substrate when no force (such as an electric field) is present or applied across that portion of the liquid crystal layer.

As used herein, a “progressive addition region” or “progressive addition zone” may refer to a lens having a first optical power in a first portion of the region and a second optical power in a second portion of the region wherein a continuous change in optical power exists there between. For example, a region of a lens may have a far viewing distance optical power at one end of the region. The optical power may continuously increase in plus power across the region, to an intermediate viewing distance optical power and then to a near viewing distance optical power at the opposite end of the region. After the optical power has reached a near-viewing distance optical power, the optical power, may decrease in such a way that the optical power of this progressive addition region transitions back into the far viewing distance optical power. A progressive addition region may be on a surface of a lens or embedded within a lens. When a progressive addition region is on the surface and comprises a surface topography it may be known as a progressive addition surface.

As used herein, a “static lens” or “static optic” may refer to a lens having an optical power which is not alterable with the application of electrical energy, mechanical energy or force. Examples of static lenses include spherical lenses, cylindrical lenses, Progressive

Addition Lenses, bifocals, and trifocals. A static lens may also be referred to as a fixed lens. A lens may comprise a portion that is static, which may be referred to as a static power zone, segment, or region.

As used herein, an “unwanted astigmatism” may refer to any unwanted aberrations, distortions or astigmatism found within a Progressive Addition Lens (or any other optical feature or property of a lens) that are not part of the patient's prescribed vision correction, but rather are inherent in the optical design of a PAL due to the smooth gradient of optical power between the viewing zones. Although, a lens may have unwanted astigmatism across different areas of the lens of various dioptric powers, the unwanted astigmatism in the lens generally refers to the maximum unwanted astigmatism that is found in the lens. Unwanted astigmatism may also refer to the unwanted astigmatism located within a specific portion of a lens as opposed to the lens as a whole. In such a case qualifying language is used to indicate that only the unwanted astigmatism within the specific portion of the lens is being considered.

Embodiments provided herein may comprise optical devices, and methods for manufacturing optical devices, that comprise a liquid crystal (LC) alignment layer(s) that orients the LC molecules of a LC layer such that the LC layer may provide a desired optical feature or features. In some embodiments, the alignment layer may comprise a nano-structured alignment layer having topographical features that have a dimension that is less than 2 μm. The optical properties of the LC layer may be based, at least in part, on the orientation (i.e. the pre-tilt angle) of the LC molecules within each portion of the LC layer. The LC layer may provide a single optical feature (such as an optical power needed for a wearer's prescription or to cancel or reduce distortion provided by a static optical component or component), a variety of optical features (such as, for example, a plurality optical add powers for a multi-focal lens and/or for reducing or cancelling multiple distortions that may be disposed in different viewing areas of the optical device), and/or a variable optical property (such as by providing a progressive optical power).

Conventionally, the LC alignment of devices that comprise a LC layer is created by the unidirectional mechanical rubbing of polymer films with a rubbing cloth. This method has been widely used due to its simplicity, durability and low-cost. However, the generation of dust and electrostatic surface charge during the rubbing, as well as mechanical surface defects, may be detrimental for device performance and lifetime. Moreover, the debris generation is generally not in line with the clean-room requirements, while the high processing temperature of polyimide alignment films may limit their application on many flexible substrates. The rubbing method may also have a limitation of achieving different LC molecule orientations within micron-size (or smaller) domains. To overcome the limitations of mechanical rubbing, other methods for generation of surface anisotropy have been proposed. Among the alternatives, one of the more promising is the process of photoalignment, which utilizes polarized light to generate chemical anisotropy on photo-reactive surfaces via directional photo-reaction (e.g. isomerisation, anistropic cross-linking or directional photodegradation). Anisotropic intermolecular interactions between different surface molecular species have been shown to be sufficient to align the LC molecules. Photoalignment offers the possibility of micropatterning via photo-mask for multi-domain LC orientations, as well as feasibility on flexible substrates. However, the majority of the photoalignment materials suffer from long-term stability issues (e.g. light, thermal and/or chemical instability). This may make them less then desirable, particularly for everyday use and applications where the material may be exposed to such conditions.

Therefore, some embodiments provided herein may generally relate to devices that utilize a LC material (i.e. in the form of a LC layer) oriented on a nano-structured alignment layer(s). In some embodiments, the nanometer-size surface features of the alignment layer(s) (which may be produced using any suitable method, including various lithographic methods), may provide a broad spectrum of LC orientations over small domains (e.g. sub-micron size domains).

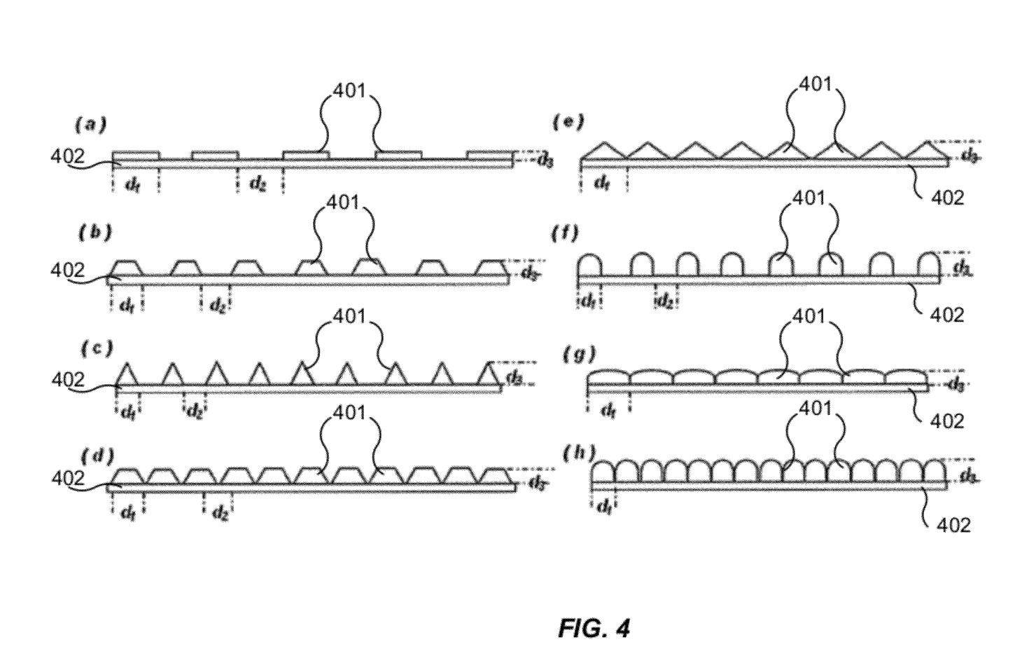

As would be appreciated by one of ordinary skill in the art, the use of the term “nano-structured alignment layer” may refer to an alignment layer having structural or topographical features that have a dimension that is less than 2 μm, as was defined above. An example of such features are shown in FIG. 4 and described below.

The use of nano-structured alignment layers may provide some embodiments with the advantage of having sufficient control of the orientation of the LC molecules so as to enable more complex (and potentially variable) optical properties across the surface of a lens using the LC layer, while also providing for devices that are more resilient and thereby less subject to failures (such as those associated with mechanical rubbing or photoalignment). That is, for example, a nano-structured alignment layer may, in some instances, be less susceptible to degradation from environmental conditions such as UV radiation and heat (in contrast to a photoalignment layer). Moreover, the topographical features of the alignment layer that may have a dimension of less than 2 μm (preferably less than 100 nm in some instances) may provide greater design choice and capability in creating and controlling the optical features across a device (unlike mechanical rubbing).

### Electro-Active Embodiments

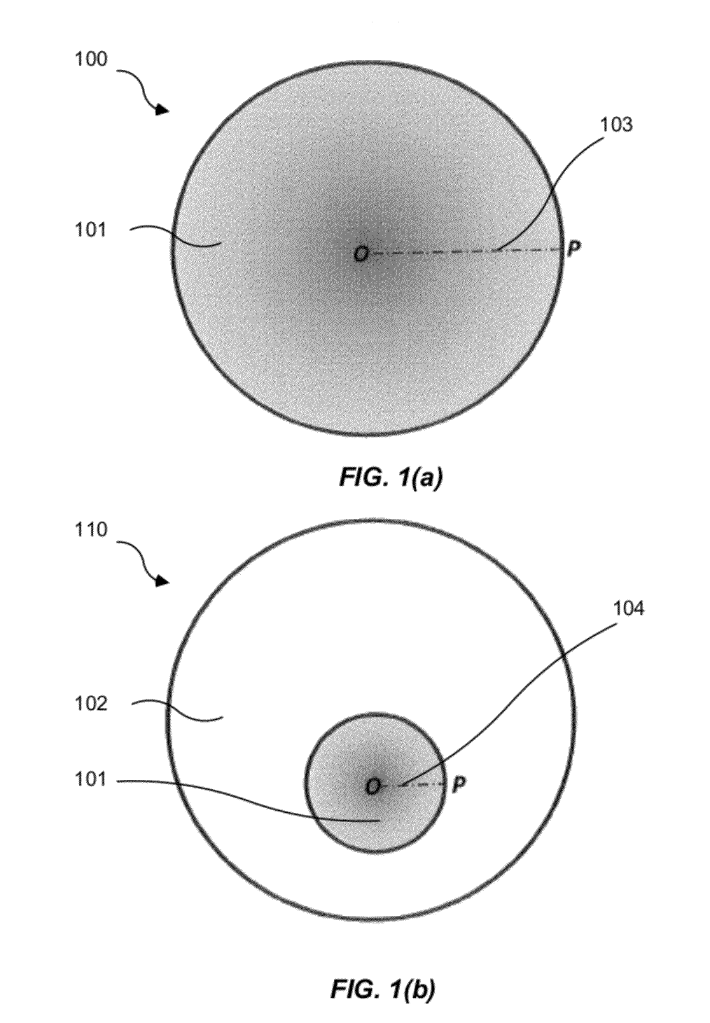

Some embodiments provided herein may relate to electro-optical devices having a variable power optical element (e.g. optical or ophthalmic lens) utilizing a LC layer oriented on one or more nano-structured alignment layers. The optical power may be changed electrically by the application of an electrical field between two transparent electrodes, which may be coated with the alignment layers and may contain, for example, a nematic or cholesteric LC layer. A schematic presentation of exemplary lenses having dynamic optical properties as described in accordance with some embodiments are shown in FIGS. 1-3, and described below.

With reference to FIGS. 1(a) and (b), two exemplary lenses 100 and 110 are shown in accordance with some embodiments. In FIG. 1(a), the lens 100 is shown as comprising a LC layer 101 (and/or an alignment layer that may be operatively coupled to the LC layer) that substantially covers (or is coated over) an entire surface of the lens 100. That is, for example, the distance given by the dotted line 103 from the approximate center of LC layer 101 (labeled as point “O”) to the edge of the LC layer 101 (labeled as point “P”) corresponds to the approximate radius of the lens 100. In this manner, the LC layer 101 may have optical properties that affect the optical power provided by the entire surface of the lens 100. In some embodiments, the alignment layer may have a structure and properties that adjust the pre-tilt angle of the LC molecules across the entire LC layer 101 or portions thereof. In some embodiments, the alignment layer may affect the pre-tilt angle of the LC molecules in different portions of the LC layer 101 such that the lens 100 may have different optical properties in different viewing areas based on the optical powers provided by the LC layer 101.

In general, providing a LC layer 101 and/or an alignment layer (e.g. a nano-structured alignment layer) over substantially all of a surface of a lens 100 may provide some advantages. For example, this configuration may provide a more efficient manufacturing process because, for instance, a custom size alignment layer need not be applied for each lens based on the prescription of a wearer or an intended use, but instead each alignment layer may be applied uniformly to a substrate and then later altered to have a structure and properties to affect the optical properties of an adjacent LC layer 101 as needed. In addition, by applying the alignment layer and the LC layer 101 over substantially the entire surface of the lens 100, embodiments may be more adaptable to correct or reduce distortions (such as unwanted astigmatism) that may be created by other optical components in different areas of the lens 100.

FIG. 1(b) shows an exemplary lens 110 in which the LC layer 101 (and/or the alignment layer) covers only a portion of the surface of the lens 110. That is, for example, the distance given by the dotted line 104 from the approximate center of the LC layer 101 (labeled as point “O”) to the edge of the LC layer 101 (labeled as point “P”) is less than the approximate radius of the lens 110. The other portion 102 of the lens 110 may not be in optical communication with the LC layer 101 and therefore an optical power provided by this portion of the lens 110 may not be affected by the LC layer 101. However, embodiments are not so limited, and in some instances a plurality of physically separate LC layers 101 may be positioned in different locations on the surface of the lens 110. For example, the LC layers may be disposed in locations so as to cancel or reduce distortions or unwanted astigmatism created by other optical components.

In some embodiments, the LC layer 101 could, for instance, correspond to the region of the lens 110 that provides a progressive addition power. For example, in some embodiments, the alignment layer (e.g. a nano-structured alignment layer) may be configured to affect the pre-tilt angle of the LC layer 101 so as to reduce or cancel the add power of the progressive addition region (or the distortion associated with the progressive addition region) when no electric field is applied (e.g. in an “OFF” state), but the LC layer 101 may provide additional plus optical power to the progressive addition region when an electric field is applied across the LC layer 101 (e.g. in the “ON” state). In this manner, embodiments may reduce the unwanted astigmatism created by a progressive addition region and/or provide additional add power to the region of the lens when desired. However, embodiments are not so limited, and a device that comprises a LC layer 101 (and/or an alignment layer such as a nano-structured alignment layer) that does not cover substantially all of the surface of a lens 110 may be used for any suitable purpose.

Although FIGS. 1(a) and 1(b) illustrate the LC layer 101 and the corresponding alignment layer as substantially symmetrical and circular, embodiments are not so limited. That is, in general the alignment layer and the LC layer 101 may have any suitable shape and any suitable size, including asymmetrical shapes. For example, in some embodiments, the alignment layer and/or the liquid crystal layer may have a shape corresponding to a progressive addition region. However, other shapes are possible and may be chosen based on the intended use of the lens, including the individual prescription of a wearer and/or the shape and style of the lens.

It should be noted that although FIGS. 1(a) and 1(b) were described above with regard to exemplary electro-active embodiments, devices provided herein are not so limited. That is, the descriptions provided above with regard to the size and the placement of the alignment layer and/or the LC layer may apply equally to some of the static embodiments that may comprise reactive mesogens, such as those described below.

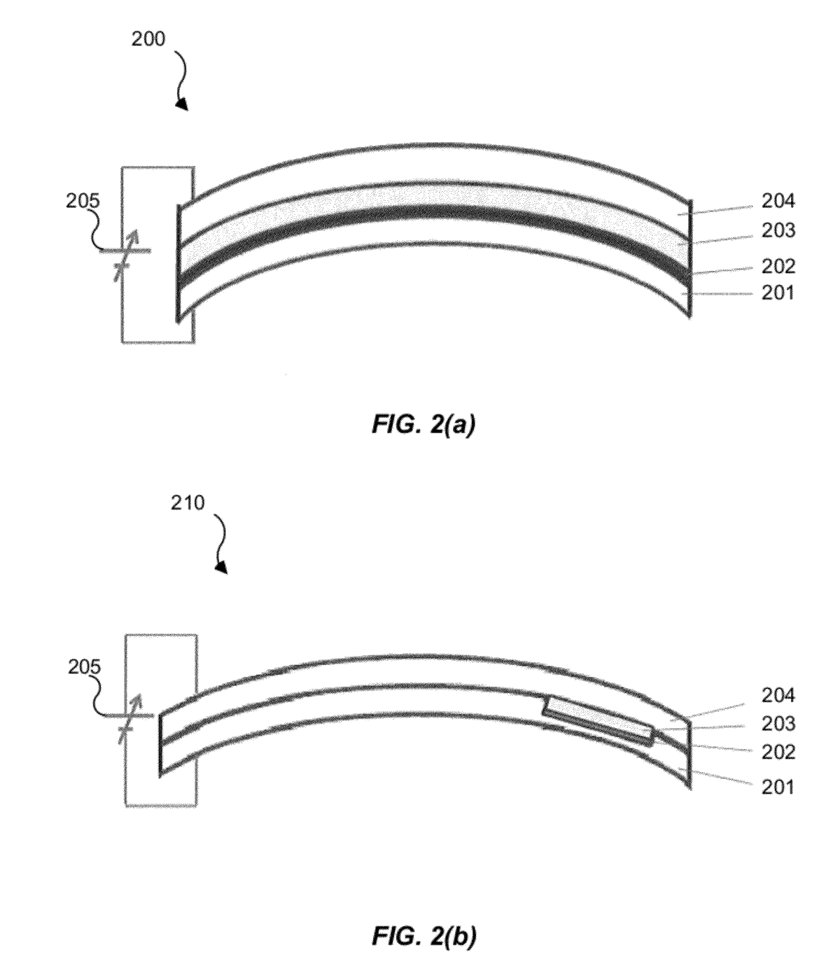

FIGS. 2(a) and 2(b) show cross sectional views of the exemplary lenses shown in FIGS. 1(a) and 1(b), respectively, in exemplary electro-active embodiments. With reference to FIGS. 2(a) and 2(b), exemplary lenses 200 and 210 are shown. Each of these exemplary lenses comprises a first substrate 201, an alignment layer 202 (e.g. a nano-structured alignment layer), a LC layer 203 that is operatively coupled to an alignment layer 202 (i.e. the two layers may be adjacent to one another or otherwise disposed such that the alignment layer may affect the orientation of the liquid crystal molecules in the LC layer 203), a second substrate 204, and a power source 205. Not shown in the figures are the first or the second electrodes that may be disposed between the first substrate 201 and the second substrate 204. The LC layer 203 and the alignment layer 202 may be disposed between the first and the second electrodes. In some embodiments, the alignment layer 202 may be disposed on the surface of the first or the second electrode. The first and the second electrode may comprise any suitable material and are preferably transparent, semi-transparent, or translucent. For instance, in some embodiments, the first and the second electrode may comprise a transparent conductive oxide (TCO) such as ITO or IZO. An electrical connection may be made from the first and second electrode to the power source 205 in any suitable manner. The electrodes may comprise a single continuous layer or one (or both) of the electrodes may be pixilated or otherwise segmented. The first substrate 201 and the second substrate 204 may comprise any suitable material, such as a plastic, glass, or optical resin material.

FIG. 2(a) illustrates an embodiment of a lens corresponding to FIG. 1(a) where the alignment layer 202 and the LC layer 203 cover substantially all of a surface of the first substrate 201 (and correspondingly the second substrate 204). In such embodiments, the first and the second electrodes may also cover substantially the entire surface of the first 201 and the second 204 substrates such that an electric field may be applied across the entire LC layer 203. In contrast, FIG. 2(b) shows an embodiment corresponding to FIG. 1(b) in which the alignment layer 202 and the LC layer 203 cover only a portion of the surface of the first substrate 201 and the second substrate 204. Similarly, the first and the second electrode may also cover an area of the lens 210 that corresponds to the area covered by the alignment layer 202 and the LC layer 203; however, embodiments are not so limited.

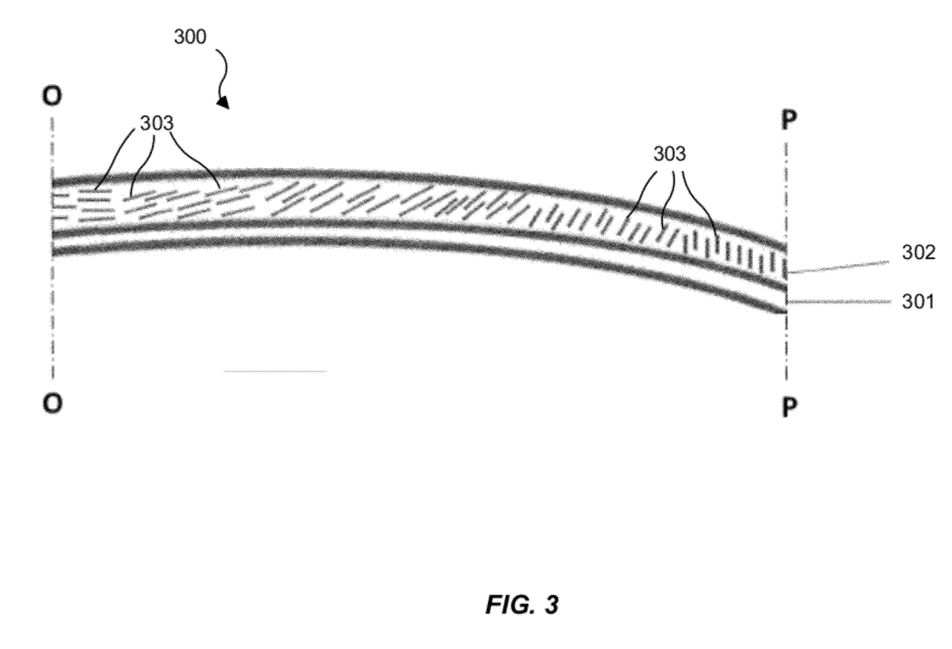

FIG. 3 is an illustration of a portion of an exemplary lens 300, and, in particular, FIG. 3 shows a cross sectional view of an alignment layer 301 and an adjacent LC layer 302. Similar to the exemplary embodiments show in FIGS. 1(a) and (b), the alignment layer 301 and LC layer 302 have an approximate center disposed at the point labeled “O,” and the two layers have a boundary designated as point “P.” The LC molecules 303 comprising the LC layer 302 are shown as having various pre-tilt angles (ranging from 0 to 90 degrees). For example, the LC molecules 303 disposed near the center of the LC layer 302 are shown as having substantially no pre-tilt angle (i.e. 0 degrees). Moving away from the center of the LC layer 302, the pre-tilt angle of the LC molecules 303 of the LC layer 302 begins to increase until the LC molecules are oriented roughly vertically (i.e. having a pre-tilt angle of approximately 90 degrees) near the edge of the LC layer (e.g. near point P). The use of a nano-structure alignment layer in some embodiments may provide optical devices that can orient the LC molecules 303 in such a continuous manner based on, for instance, controlling the shape, size, and/or spacing of the topographical features. In this manner, embodiments may, for instance, provide an optical power profile of the LC layer 302 that varies continuously such that the LC layer 302 may provide a greater plus optical power at its center, and may then decrease in optical power as the distance from the center of the LC layer 302 increases. However, embodiments are not so limited, and the LC molecules 303 of the LC layer 302 may be oriented by the alignment layer 301 so as to have any desired pre-tilt angle to create a desired optical effect for the optical device 300.

As noted above, the pre-tilt angle of the LC molecules 303 of the LC layer 302 may be determined, at least in part, by the structure and the characteristics of the alignment layer 301. Thus, the properties and features of the alignment layer 301 may be varied to create the desired optical performance of the LC layer 302, such as to continuously vary the pre-tilt angle of the LC molecules 303 as shown in FIG. 3. However, embodiments are not so limited, and the alignment layer 301 may have any properties that orient the LC molecules 303 of the LC layer 302 so as to provide a desired optical effect across any portion or portions of the LC layer 302. This may include, for example, discreetly or continuously varying the pre-tilt angles of the LC molecules, which may affect the optical power across the lens (or portions thereof) such as by providing multiple optical powers across the lens, reducing or cancelling unwanted astigmatism, etc.

### Nano-Structure Alignment Layer

In some embodiments, a lens may be provided that comprises a nano-structured alignment layer and a liquid crystal layer adjacent to the nano-structured alignment layer. In some embodiments, the nano-structured alignment layer may provide a continuous or a discrete change in a pre-tilt angle of liquid crystal molecules of a portion of the liquid crystal layer over any range between approximately 0° to approximately 90°. As used in this context, “continuous change” may refer to when the pre-tilt angle of the LC molecules vary by at least 10 degrees over a distance of 1 mm, but within that same 1 mm distance, the LC molecules do not vary by more than 5 degrees over a distance of 10 μm.

As noted above, embodiments provided herein may comprise an alignment layer having a structure and properties (along with the properties of the LC layer) that may be used to orient the pre-tilt angle of LC molecules that comprise a LC layer of an optical device. In some embodiments, the alignment layer provided herein (which may provide the LC orientation in the field-free state of the optical lens operation) may comprise layers with nanometer-size topographic features. A broad spectrum of surface topographies (e.g. nanometer-size anisotropic surface features) may be used to provide specific LC molecule orientations, ranging from no-tilt in-plane (planar) LC molecule orientation to, via a variety of predetermined tilt-angle LC orientations, fully vertical (homeotropic) LC molecule orientation. Some of the examples of surface features of the alignment layer that may be used in some embodiments to orient the overlaying LC molecules are presented, but are not limited to, those exemplary configurations given in FIGS. 4(a)-(h), and described in more detail below.

With specific reference to FIGS. 4(a)-(h), eight portions of exemplary nano-structured alignment layers are shown. It should be understood that the topographical structures and features of the alignment layers disclosed in FIGS. 4(a)-(h) are provided for illustration purposes only and are not meant to be exhaustive or limiting. In general, the alignment layers may have features that have any suitable size, shape, properties, and/or be disposed at any distance relative to one another so as to achieve a desired pre-tilt angle of the LC molecules of a particular portion of the LC layer.

As shown in the exemplary embodiments in FIGS. 4(a)-(h), each portion of the nano-structured alignment layer comprises a plurality of topographical features 401 disposed over a substrate 402 (such as an electrode or a lens component). Each of the features 401 is shown as having a width equal to d₁ and a height equal to d₃. Moreover, in the exemplary embodiments shown in FIGS. 4(a), (b), (c) and (f), each feature is shown as separated by a distance of approximately d₂, whereas in FIGS. 4(d), (e), (g), and (h), where the features are shown as substantially physically connected, the distance between the approximate geometric center of each of the features is labeled as d₂. In general, the topographical features of the nano-structured alignment layer, or portions thereof, may have at least one of these dimensions that is less than 2 μm. In addition, in some embodiments, the topographical features may be controlled, such that the features that may have a dimension that is less than 2 μm are designed or arranged in a predetermined matter that may be intended or predictable. That is, for instance, the position, shape, and size of each feature may be predetermined for each individual component of the pattern. This may be in contrast to a structure that occurs from traditional alignment layer fabrication methods such as rubbing (scratching), which produce random structure and patterns, typically at dimensions of more than 1 micron.

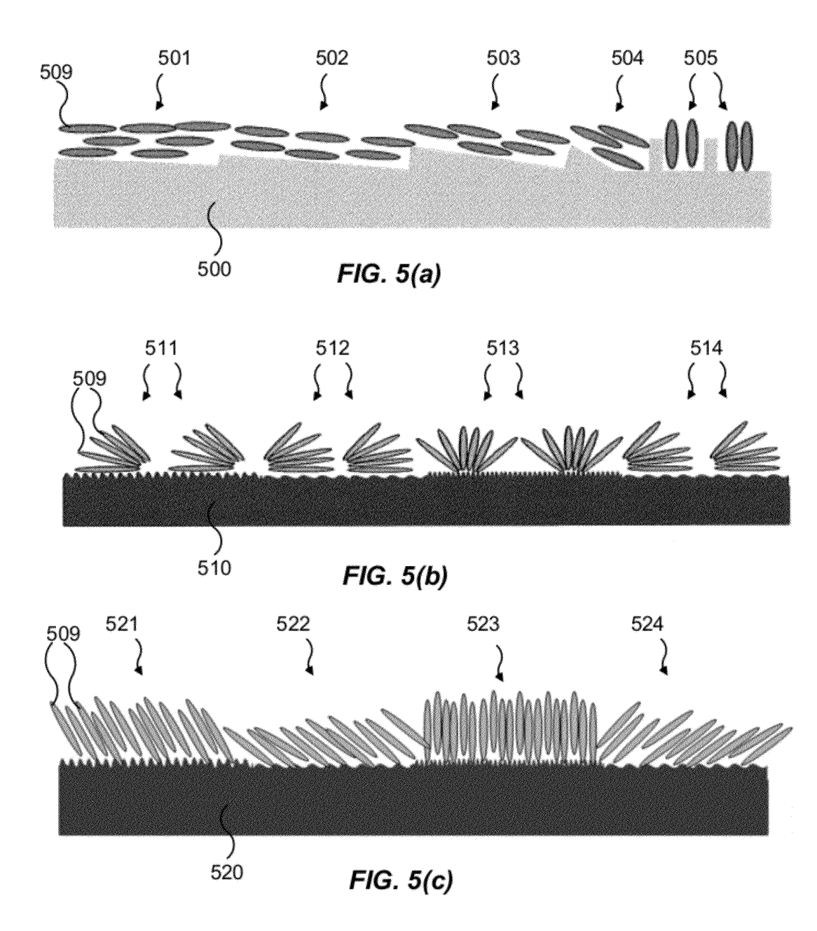

It should be noted that although the features in FIGS. 4(a)-(h) are each shown as being uniform and repeating, embodiments are not so limited. Indeed, in some embodiments, the size (e.g. dimensions d₁ and/or d₃) and relative distances between the features (e.g. d₂) may be varied so as to vary the orientation of the LC molecules of a LC layer that is operatively coupled to the alignment layers. That is, for example, each topographical feature of an alignment layer (or a portion thereof) need not have the same feature width d₁ or height d₃, but may have a range of heights (such as up to 2 μm, but preferable between 10 and 200 nm, which is a range that the inventors have found provides sufficient control of the LC molecules, while comprising dimensions that may be fabricated using known techniques, such as lithography). Similarly, the distance d₂ between topographical features may also be varied. The variation in each of these features may increase or decrease the pre-tilt angle of the corresponding LC molecules of a LC layer. Examples of varying topographical features of portions of alignment layers are shown in FIGS. 5(a)-(c) and described in more detail below.

Particularly, in some embodiments of a variable power optical lens described herein may utilize an alignment layer with surface features that progressively vary in the groove's tilt, and thus, provide a continuous change in the pre-tilt angle of the overlaying oriented LC molecules from, for example, 0° to 90°. For instance, the surface features in the center of the optical lens may provide 0°-pre-tilt angle, while at the lens periphery, the topography may be such that LC molecules are oriented perpendicularly to the alignment surface. Due to the changes in the LC orientation, the refractive index may progressively vary from the value for planar orientation in the lens center (i.e. average refractive index for the LC material used, n_{avg}=(nₑ+nₒ)/2, where nₑ is the extraordinary refractive index and nₒ is the ordinary refractive index) to the refractive index exhibited by vertical LC alignment in the lens periphery (i.e. ordinary refractive index, nₒ).

Examples of varying topographical features on a single alignment layer inducing different LC orientations are given in FIGS. 5(a)-(c). With reference to FIG. 5(a), an embodiment of an alignment layer 500 is shown that comprises a plurality of topographical features in the form of grooves 501-505 in a planar LC layer. Each of the grooves 501-505 affects the orientation (i.e. the pre-tilt angle) of the LC molecules 509 of the adjacent portion of the LC layer. Moving from left to right in FIG. 5(a), the grooves in this exemplary embodiment gradually begin to get steeper and are disposed closer together, causing the pre-tilt angle of the LC molecules 509 to increase. For example, groove 501 is longer (and thereby less steep) than groove 504 or grooves 505, and therefore the LC molecules 509 adjacent to groove 501 have less pre-tilt angle than the LC molecules 509 adjacent to grooves 504 and 505. In this manner, the pre-tilt angle of the LC molecules 509 and thereby the optical properties of the LC layer may be varied. Depending on the number of grooves and the difference in the depth and length of the groves, this may cause a continuous change in the pre-tilt angle of LC molecules 509 (e.g. less than 5 degrees of change in tilt angle over a distance of 10 μms).

FIGS. 5(b) and 5(c) show additional exemplary embodiments of alignment layers 510 and 520 that create a variety of pre-tilt angles of the LC molecules 509 in splayed LC layers. That is, for instance in FIG. 5(b), the alignment layer 510 comprises a plurality of regions 511-514, each having a plurality of topographical features. The topographical features vary such that, for example, the LC molecules in region 511 have a different orientation than the LC molecules in region 512, 513, or 514. Thus, the different regions of the LC layer may each have different optical properties that may be based, at least in part, on the varying topographical features of the nano-structured alignment layer 510. Similarly, in FIG. 5(c), a nano-structured alignment layer 520 comprises a plurality of regions 521-524, each having a plurality of topographical features. The topographical features vary such that, for example, the LC molecules in region 521 have a different orientation than the LC molecules in region 522, 523, or 524. As illustrated in this example, the regions 521 and 523 where the topographical features are disposed closer together may create LC molecules 509 with a greater pre-tilt angle than regions 522 and 524 that have features that are separated by a greater distance and/or have a lower height. Thus, the different regions of the LC layer may each have different optical properties that may be based, at least in part, on the varying topographical features of the nano-structured alignment layer 520.

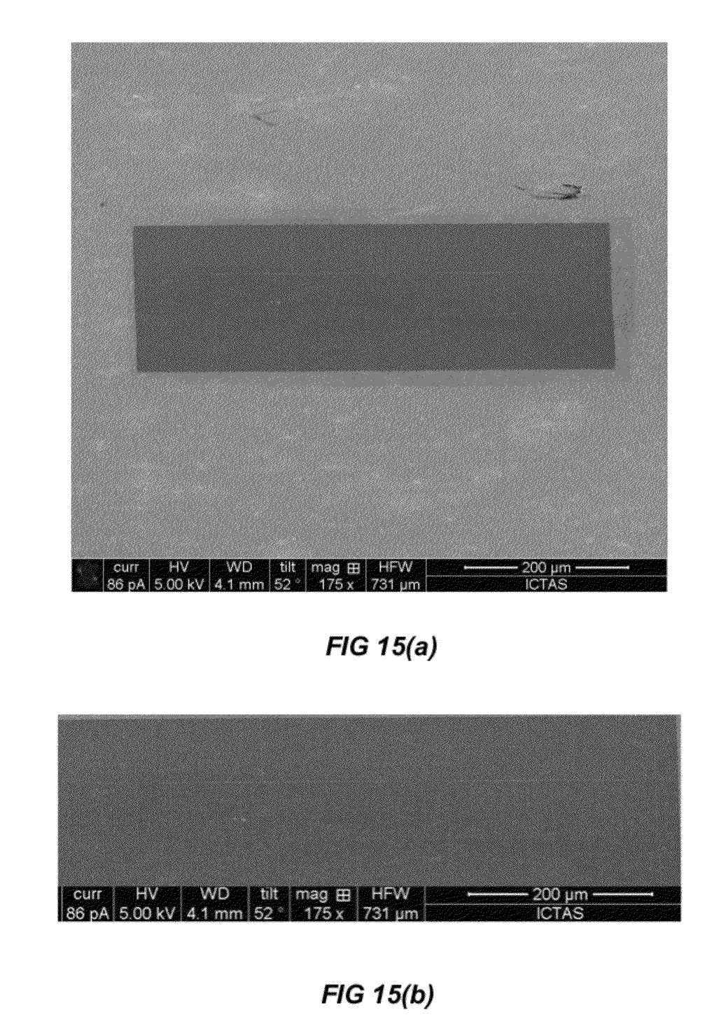

Embodiments of a nano-structured alignment, such as the ones described above, may be fabricated in any suitable manner using any known suitable method. For instance, in some embodiments, the alignment layer material may be deposited onto a lens substrate (such as a lens blank or an electrode), and the desired or predetermined topographical features may be defined in a separate step. For example, the features may be defined from a base layer of material using lithography (e.g. nanoimprint lithography, electron beam lithograph, proton beam writing, etc.), or any other suitable process that is generally known to one of ordinary skill in art. In this regard, the inventors have experimented using focused ion beam (FIB) technique using gallium ions to fabricate parts of a nanostructure alignment layer. An image of the experimental alignment layer comprising a plurality of nano-grooves made with a FIB-method (using Ga+2 ions and bombardment of an ITO-coated surface) is shown in FIG. 15(a), with a focused view in FIG. 15(b). In some embodiments, the alignment layer may be deposited in such a way that the topographical features are defined in the deposition process, such as by deposition through a shadow mask or other similar process. The alignment layer may also comprise any suitable material, including, by way of example only, polyimide, polyvinyl alcohol, polyacrylate, polymethacrylate, polyurethane or epoxy material.

In general, by variation of anyone of, or some combination of: (a) LC layer material properties (e.g. dielectric anisotropy, threshold voltage, etc.); (b) alignment layer material properties (e.g. polar and azimuthal anchoring strength); and (c) topographic features of the alignment layer, embodiments may provide a wide spectrum of LC molecule responses whether under an applied electric field or not. For instance, optical elements designed in accordance with some of the features provided herein may work as converging or diverging optical lens. For example, in some embodiments, the optical power in the “OFF” state of the lens may be given by t(nₑ−nₒ)/R², where t is the thickness of the LC layer and R is the radius of the lens, while the optical power of the same lens may be zero in the “ON”-state (e.g. when an electric field is applied, substantially all of the LC molecules may align with the electric field, and therefore there may no longer be a variation across the LC layer).

With reference to international patent application WO2010/076471 A1, which is hereby incorporated by reference in its entirety, described therein is a variable power optical element using nematic or cholesteric LC where closed cells with different LC orientations are physically separated with walls. In order to provide different LC orientations on a single uniaxially rubbed alignment film in the “ON”-state of the element, the bias electrodes have to be circular and concentric, and are insulated from each other. That is, in the “ON”-state, different electric fields are applied across different portions of the LC layer to provide a variable optical property. WO2010/076471 A1 also describes a variable optical power element using two continuous electrodes, but this needs two different LC materials disposed in several mixtures (i.e. the device utilizes two different LC materials disposed in different amounts in different regions of the device).

Some embodiments provided herein may overcome the need of separating portions of the lens and/or using divider walls by, for instance, utilizing an alignment layer with locally distinct topographies (see, e.g. FIG. 3). In general, divider walls between cells of different LC orientations, like those proposed in WO2010/076471 A1, may cause light scattering and other undesirable effects. Furthermore, some embodiments provided herein may not require the use of bias concentric circular electrodes, because some embodiments may, for instance, utilize alignment layers having distinct topographies that may dictate different LC orientations over the lens surface. In this manner, some embodiments provided herein may use continuous electrodes and/or a single LC material and achieve variable optical properties across a lens based on the optical powers provided by the LC layer. However, embodiments are not so limited, and may generally use any electrode configuration and/or any LC material(s).

Embodiments of optical devices that may comprise a nano-structured topography may provide some advantages. For example, some embodiments may provide a LC layer having variable optical properties that utilizes a single LC material and/or does not need to utilize separation walls between different portions of the LC layer. This may reduce light scattering of the device and/or reduce manufacturing costs, materials, and complexity associated with depositing multiple LC material or creating such partitioned areas. In some embodiments, the use of a nano-structured alignment layer may provide a lens (or portion of a lens) having variable optical properties without requiring the use of concentric electrodes and/or the application of different voltages across different portions of the LC layer. This may reduce the costs associated with patterning and depositing electrodes, as well as reduce the complexity of any control hardware and software of the device. Utilizing continuous electrodes may further reduce the failure rates of devices that may be associated with any shorts that may develop between electrically isolated electrodes. It should be noted that although embodiments may reduce the need for such device components and configuration, in some embodiments, a lens comprising a nano-structured alignment layer may include one or more the features mentioned above.

In some embodiments, alignment layers that comprise a controlled nano-structure topography may provide a broad range of pre-tilt angles of adjacent LC molecules and thereby provide a wide range of spatial distributions of refractive index over an area of the lens. In this manner, the use of a nano-structured alignment layer may provide a wide range of optical power—e.g., anywhere from approximately +0.25 to approximately +4.0 Diopters. In some embodiments, the LC material may be disposed over the whole lens area (e.g. as shown in FIG. 1(a)) or in a small part or portion of the lens (e.g. as shown in FIG. 1(b)).

### Static Optical Element Embodiments

In some embodiments, devices provided herein may comprise a static optical element comprising a coating (e.g. comprising LC molecules) with a customized refractive index profile (e.g. a refractive gradient). Such optical elements can be used for any suitable purpose, such as an ophthalmic lens (e.g. as progressive lens) that may be customized according to a given wearer's prescription. The coating (i.e. a LC layer) that may have a controllable spatial refractive index distribution may be composed of reactive mesogens, which may provide a variety of refractive index distributions in the x-, y-, and z-directions depending on, for instance, their chemical nature, coating method, and processing conditions. In some embodiments, the coating (i.e. LC layer) with a customized refractive gradient may be applied to the front or rear face of a lens substrate (e.g. to a semi-finished blank or to a finished blank) to further correct the optical power, astigmatism and/or the length of progression (in the case of progressive lens) according to the wearer's prescription. With other words, in some embodiments, the optical power and astigmatism to an extent may be dictated by the lens front and rear faces, but the final fine tuning of the optical properties, unique for each wearer, may be provided by the coating (i.e. LC layer). This may enable the manufacture of generic optical prescriptions in mass quantities, with the customization of to a wearer's prescription being completed by adjusting the optical properties of a thin coating applied to a surface of the lens. In some embodiments, corrections for other eye problems (e.g. for ametrophia and others) are possible with the proposed coating.

In some embodiments, the LC layer may include a polymer network formed from polymerizable monomers, preferably light or UV polymerizable monomers. Suitable monomers include generally any monomer polymerizable in the presence of the liquid crystal material utilized and generally an initiator, i.e., a photoinitiator in the case of a light or UV-curable monomer. The UV reaction may comprise a polymerization reaction wherein crosslinking between the polymer chains is also possible. As noted above, examples of suitable polymerizable monomers include, but are not limited to, reactive mesogens, for example having polymerizable functional groups, including but not limited to acrylate groups.

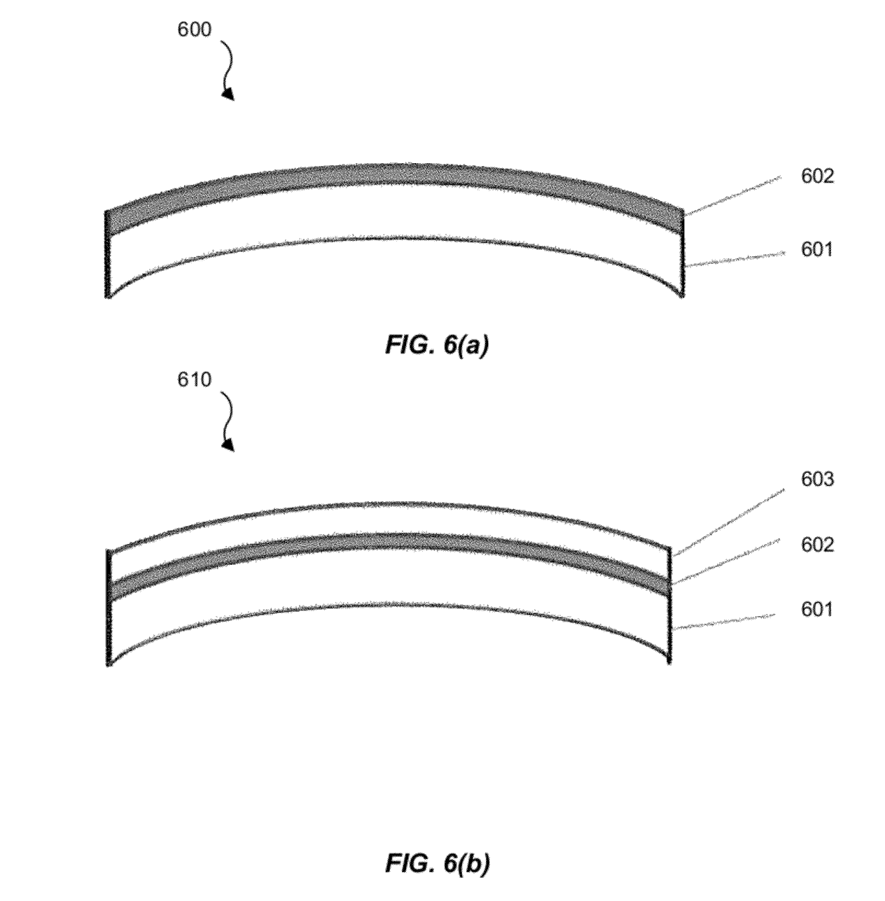

With reference to FIGS. 6(a) and (b), a cross-sectional view of two exemplary lenses 600 and 610 are provided. Each lens comprises a lens substrate 601 and a variable refractive index mesogen coating 602 (also referred to herein generally as a LC layer). FIG. 6(a) shows an exemplary lens 600 where the LC layer 602 is disposed on the front surface of the lens 600. In some embodiments, an additional scratch resistant layer may also be applied to the front of the lens 600 to protect the LC layer 602 from damage. FIG. 6(b) shows an exemplary lens 610 that comprises an additional substrate 603 that is disposed on the opposite side of the LC layer 602, such that the LC layer 602 is disposed between the first 601 and the second 603 substrate. The additional substrate 603 may protect the LC layer 602 from external forces.

In some embodiments, although not shown in FIGS. 6(a) and (b), an alignment layer (such as the nano-structured alignment layer described above), may be disposed so as to be operatively coupled to the LC layer 602 (i.e. the refractive index mesogen coating) such that the properties of the nano-structured alignment layer may determine the pre-tilt angle of the LC molecules. In this manner, the lens 600 or 610 may have a variable optical property based, at least in part, on the topographical structure and other properties of the alignment layer. The RM of the LC layer (i.e. the refractive index mesogen coating) may then be polymerized using, for instance, UV light, so as to maintain the pre-tilt angle.

In this manner, static optical lenses and components thereof may comprise an active material that may have the pre-tilt angle of its liquid crystal molecules oriented so as to provide an optical property (optical properties) to a lens or portions thereof. As noted above, such materials that may comprise the LC layer (i.e. the variable-refractive-index coating) may include, by way of example, reactive mesogens (RMs). These materials generally have a low-molecular-weight, are photo-sensitive or thermally-sensitive liquid crystalline materials, and which, after proper alignment and subsequent UV-irradiation and/or heating, can form anisotropic liquid-crystalline polymer networks. Depending on the way the mesogens are distributed spatially within the polymer network, a wide spectrum of solidified anisotropic coatings can generally be prepared.

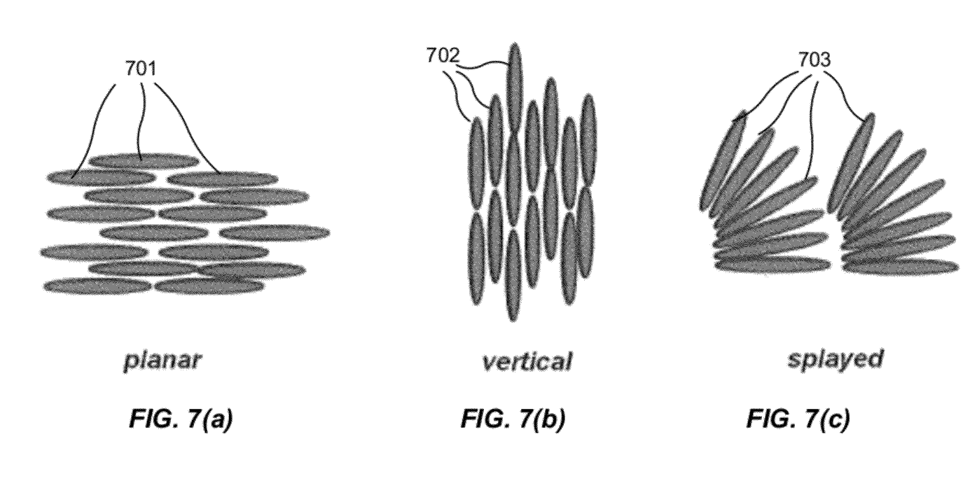

A schematic presentation of few possible (i.e. exemplary) mesogens distributions are given in FIGS. 7(a)-(c). FIG. 7(a) shows mesogens 701 aligned in a planar direction (i.e. substantially parallel to a substrate), which may correspond to a pre-tilt angle of 0°. FIG. 7(b) shows mesogens 702 aligned in a vertical direction (i.e. substantially perpendicular to a substrate), which may correspond to a pre-tilt angle of 90°. FIG. 7(c) shows mesogens 703 aligned in a splayed direction (i.e. having a variety of pre-tilt angles). One way in which the mesogens of the LC layer may have the pre-tilt angles altered is through the use of a nano-structured alignment layer, such as the embodiments described above. However, embodiments are not so limited, and there may be a variety of methods and processes that may be used to orient the pre-tilt angle instead of, or in addition to, the use of an alignment layer.

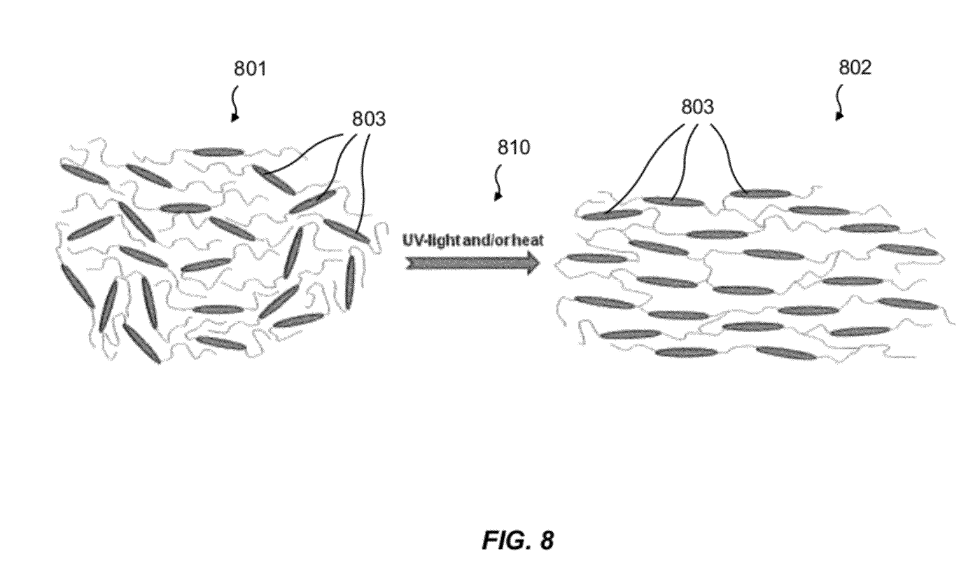

A schematic presentation of a solid LC polymer network formed by UV irradiation or thermal treatment of a LC layer comprising an RM coating is given in FIG. 8. That is, as shown in FIG. 8, on the left side is a homogeneous mixture 801 of mesogens 803 without a predefined orientation. However, with the application of, for example, UV light and/or heat as indicated by the arrow 810, an ordered polymer network 802 may form of the mesogens 803, each having a tilt or orientation that is substantially the same. Different portions of a LC layer may have differently oriented polymer networks such that the optical device may have different optical powers in different regions, as was described above.

In general, different mesogen distributions, and thus, different refractive index profiles, can be achieved using any suitable method. Provided below are some exemplary processing procedures. However, embodiments are not limited to the examples disclosed herein.

In some embodiments, the mesogens may be oriented on the exemplary nano-structured alignment layers disclosed above (i.e. alignment layers that may have variable topographical features). Each surface topography feature may give a specific mesogen orientation, which may result in a variety of localized refractive index profiles over a large-area-coating. By subsequent UV irradiation, e.g. with unpolarized UV light having a peak wavelength of approximately 365 nm, a spectrum of local refractive index distributions can be “frozen” yielding a solid-state coating with variety of localized anisotropic properties (see, e.g. FIGS. 5(a)-(c) for examples of orientations that may be provided by such alignment layers).

In some embodiments, the mesogens may be oriented on a conventional rubbed layer or photo-aligned layer, and then are processed with a focused unpolarized UV light beam (e.g.

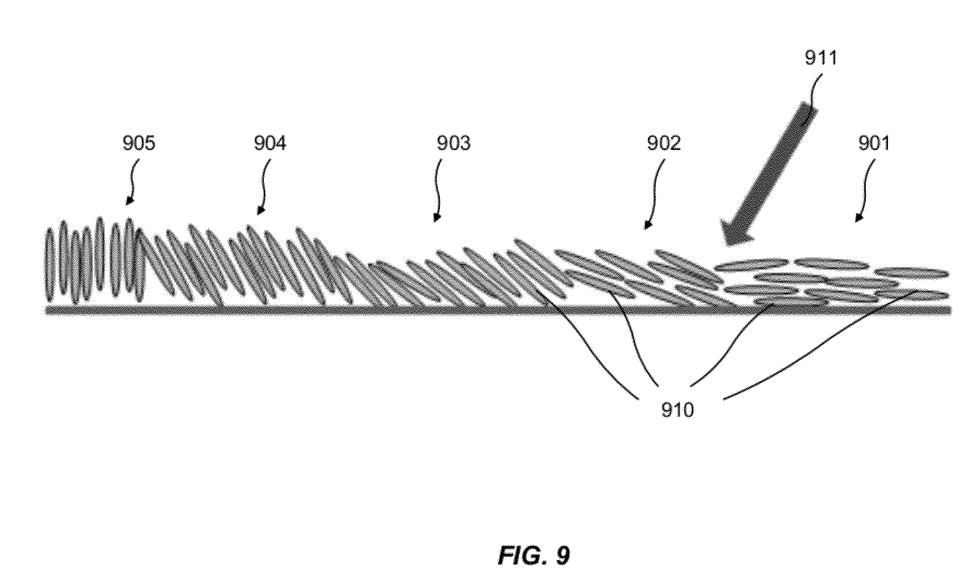

using a UV laser having a peak wavelength of approximately 365 nm) with or without local heating. The scanning UV light beam may be moved with different speeds over the mesogens' coating (or the beam may have a variable intensity during a constant speed scanning) resulting in different UV exposure doses of the mesogenic coating, and thus, in different localized refractive index profiles. The local heating may be provided by, for instance, a focused IR laser. An example of the variable intensity is shown in FIG. 9. That is, in FIG. 9, a plurality of groups 901-905 of mesogens 910 are shown as having different orientations based on the exposure to the UV beam 911. The group 901 is illustrated as having the most exposure (whether at the highest intensity levels or the greatest amount of time), and thereby the mesogens 910 are shown as being oriented substantially parallel to the substrate. Conversely, the group 905 of mesogens 910 is shown as having the least exposure to UV beam 911 and thereby the mesogens 910 are illustrated as having an orientation that is substantially perpendicular to the substrate. The mesogens 910 in groups 902, 903, and 904 each are shown as having orientations between the two extremes of groups 901 and 905, which further demonstrates the variability of the orientations of the mesogens 910 (and thereby the variety of optical powers that may be applied across a LC layer). For example, the exemplary LC layer shown in FIG. 9 may provide a continuous change in optical power over this portion of the lens (such as, for instance, by providing a progressive addition region).

In some embodiments, the mesogens may be oriented on conventional alignment layers or the exemplary nano-structured alignment layers described above (e.g. having variety of nano-size topographies). The mesogens orientation may be solidified by localized heating, which may be provided by, for example, a focused IR laser beam.

In some embodiments, a mesogen material containing a liquid crystalline photoinitiator may be oriented on the exemplary nano-structured alignment layer described above, a conventional alignment layer, or a photo-alignment layer, and then may exposed to a focused, linearly-polarized UV beam. The LC photoinitiator molecules are dichroically sensitive to the incident polarized UV light. This means that more radicals may be generated at locations where the long molecular axis of LC photoinitiator molecules is parallel to the polarization axis of the incident UV light. Thus, the photo-reaction (polymerization) may be faster at these locations. Consequently, more reactive radicals may become concentrated at these locations, while the less reactive radicals (components) diffuse away from these locations, resulting in localized concentration variations of different components, and thereby different localized refractive index profiles.

A schematic presentation of several different orientations of RM-material (e.g. splay RM, nematic RM) generated by a single-substrate nano-structured alignment layer may also correspond to the embodiments presented in FIGS. 5(a)-(c). Although this was described above with regard to electro-active embodiments, the use of the nano-structured alignment layer may be utilized in some embodiments that comprise reactive mesogens to orient the LC molecules.

In general, due to the pronounced intrinsic anisotropic properties (e.g. optical birefringence) of RM materials that may be used in some embodiments, large optical anisotropies may be possible within a very thin RM coating (e.g. within 50-100 nm thick coatings). Light beams passing through a lens coated with such coating may be significantly altered depending on the coating's spatial refractive index profile. A complex math calculation can predict the light passing and emerging from an optical element with variable refractive index coating. For instance, the second-order derivatives of the average refractive index, such as δn/δxy, δn/δx², and δn/δy² should have certain values over the lens surface depending on the wearer prescription. For example, in some embodiments using the exemplary RM coating, the mixed second-order derivative δn/δxy (i.e. the derivative with respect to the horizontal and vertical spatial coordinate) may be tuned to have maximum and minimum values reached at given points on the wearer face (i.e. in front of portions of the wearer's eye) according to the wearer's prescription, while the values in-between over the whole lens surface may change continuously. In this way, the wearer of such exemplary coated lenses may not experience disruption in his/her vision during scanning near and far objects by fast moving of the eyes due to the smooth progressive variation in the refractive indices (i.e. the refractive coating may be used to remove sudden/sharp changes in the refractive indices).

As would be appreciated by one of ordinary skill in the art, the maximum variations in the refractive indices in the x-, y- and z-direction are typically highly dependent on the materials used. In some embodiments herein, the materials comprise reactive mesogens (RMs), which can exhibit large pre-determined variation in the refractive indices nₓ, n_{y}, and n_{z}, if properly oriented. The proper RM alignment coupled with the proper subsequent processing (UV irradiation with or without the heat) may provide smooth variation in the refractive indices with respect to the pre-determined spatial coordinates.

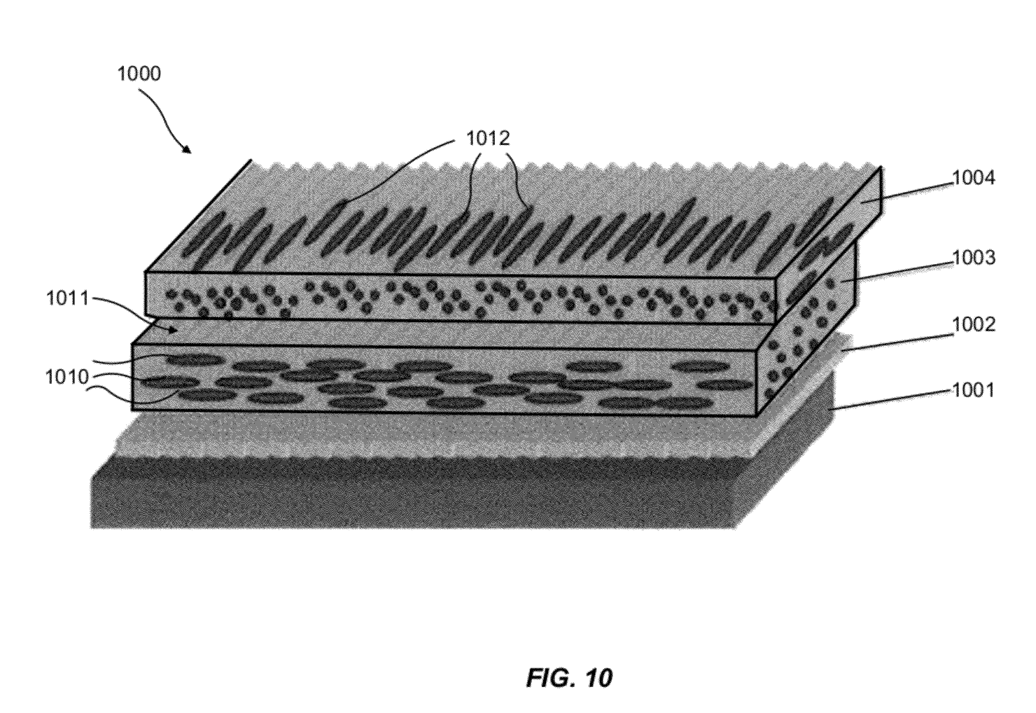

In some embodiments, to get the desirable refractive index spatial distribution, two or more different RM coatings may be applied. To avoid the application of an alignment layer for each RM coating, a nano-structured surface of the underneath RM coating may serve as an alignment layer for the next RM coating. This is schematically presented in FIG. 10.

That is, as shown in FIG. 10, in some embodiments, an optical device 1000 may comprise a plurality of LC layers (such as, for example, plurality of RM coatings). The exemplary device 1000 comprises a substrate 1001, a first alignment layer 1002 (e.g. a nano-structured alignment layer), a first LC layer 1003, and a second LC layer 1004. As shown, the first LC layer 1003 comprises a plurality of LC molecules 1010 that have a pre-tilt angle oriented substantially parallel to the substrate 1001, which may be determined, at least in part, based on the topographical features of the alignment layer 1002. The first LC layer 1003 also comprises a top surface 1011 that is shown as being disposed adjacent to the second LC layer 1004. This top surface 1011 may, in some embodiments, also comprise nano-structured topographical features that may determine the pre-tilt angle orientation of the LC molecules 1012 disposed within the second LC layer 1004. Thus, as shown, the LC molecules 1012 of the second LC layer 1004 have a pre-tilt angle orientation that is also parallel to the substrate 1001 but that is perpendicular to the direction of the pre-tilt angle of the LC molecules 1010 of the first LC layer 1003. As would be understood by one of ordinary skill in the art based on the disclosure provided herein, the alignment layer 1002 and the top surface of the first LC layer 1011 may have any features and properties (such as topographical features disposed on a surface thereof) so as to orient the LC molecules 1010 and 1012, respectively, in any arrangement or combination of arrangements to achieve an optical power profile for an optical device 1000, or a portion thereof

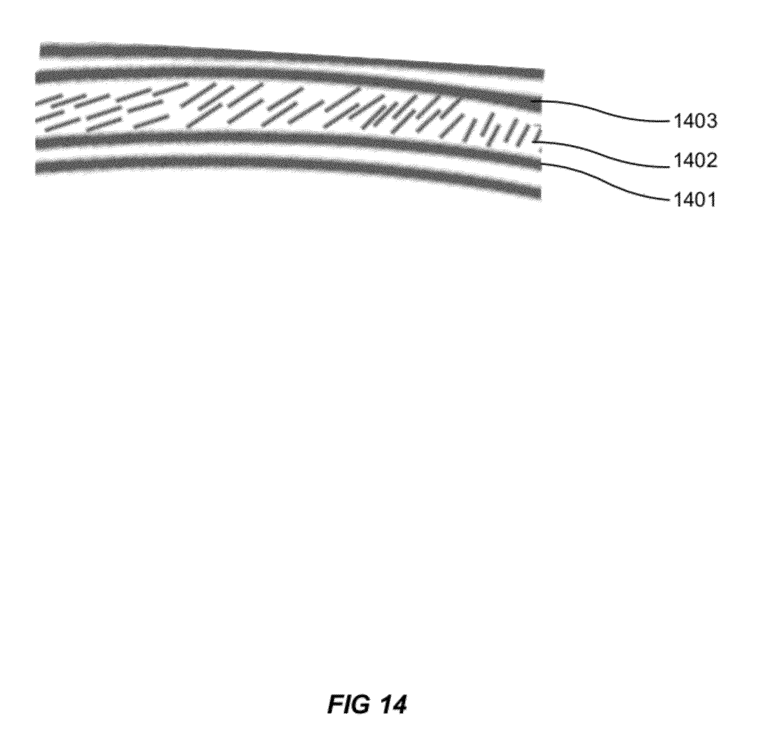

While the use of an adjacent surface of a LC layer to orient the pre-tilt angle of an adjacent LC layer as shown in FIG. 10 may reduce fabrication cost and reduce the number of layers of an optical device, embodiments are not so limited. For example, as shown in FIG. 14 some embodiments may comprise a plurality of alignment layers that may be operatively coupled to a LC layer (or layers) such that the alignment layer may affect the pre-tilt angle of the liquid crystal molecules. In particular, FIG. 14 shows a cross sectional view of an exemplary device comprising a first alignment layer 1401, a second alignment layer 1403, and a LC layer 1402 disposed there between. The alignment layers 1401 and 1403 may be configured such that the combined effect (based on, for instance, the topographic features of the alignment layers, the polarity of liquid crystal layer material, the size of liquid crystal molecules, the nature of alignment layer material, its surface energy, and/or liquid crystal layer thickness, etc.) may result in a desired alignment of the LC molecules. In general, embodiments of optical devices may provide any number of alignment layers and/or any number LC layers to achieve a desired optical property or properties. For instance, a plurality of LC layers having LC molecules with different pre-tilt angle orientations may be placed in optical communication over portions of the lens such that the optical properties of each LC layer may be combined in that location to provide the total optical power of that portion of the lens. The layers may also be arranged in any suitable manner and in any combination, such as, by way of example only, devices that comprise two adjacent LC layers disposed between two opposing alignment layers.

U.S. Pat. No. 7,837,324 B2 describes an ophthalmic lens comprising a variable refractive index layer by utilizing so-called “active” material, which can polymerize in two different phases of different refractive indices. The processing of the proposed “active” material is somehow complex involving at least two precursors, which via photo-polymerization and relatively long thermal polymerization or their combination yield the two phases in the final coating. Due to the non-existence of intrinsic anisotropy of the “active” material (which is not disclosed as a LC material), the proposed coatings are usually thicker (i.e. on the order of 0.1-1.0 mm) than the coatings proposed for some embodiments disclosed herein (which may be, in some instances, on the order of approximately 50-100 nm).

In general, the variable refractive index coating (i.e. the LC layer) can be applied using any suitable process known in the art, including, by way of example only, dip-coating, spin-coating, or other technique. The refractive index coating can be applied in the laboratories located between the lens manufacturers and the retail sales centers or even in the ophthometric centers, once the wearer prescription is known and the lens can be customized to the wearer.

### Exemplary Optical Power Profiles

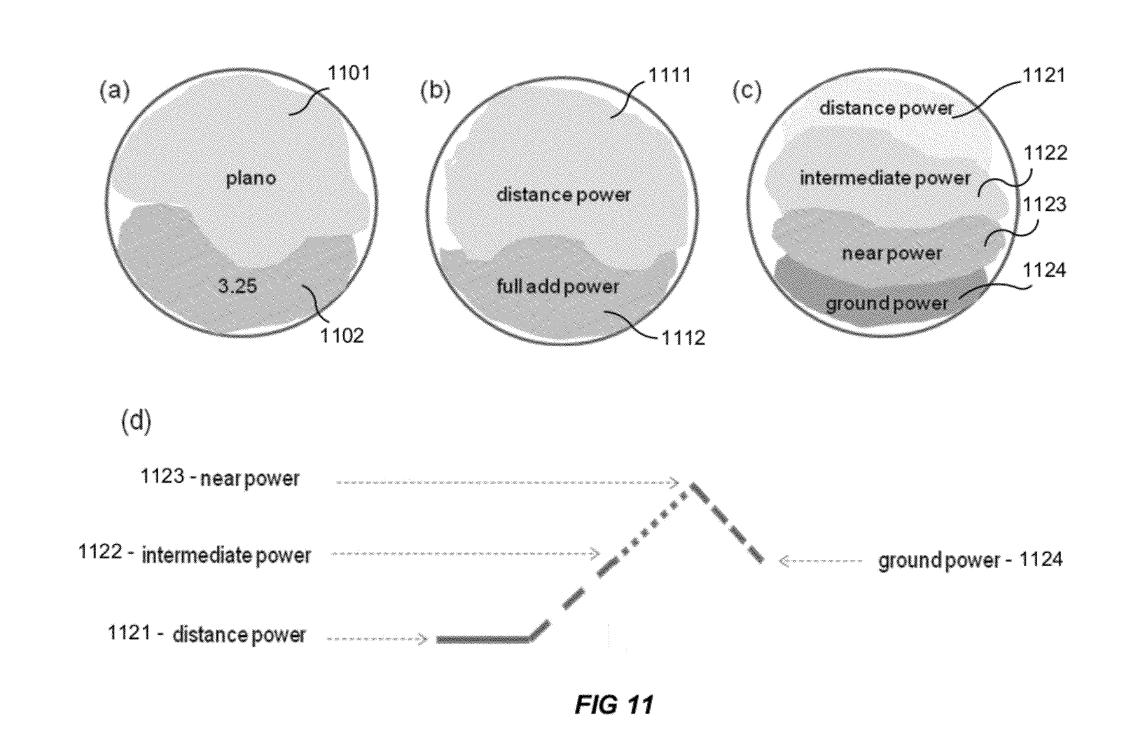

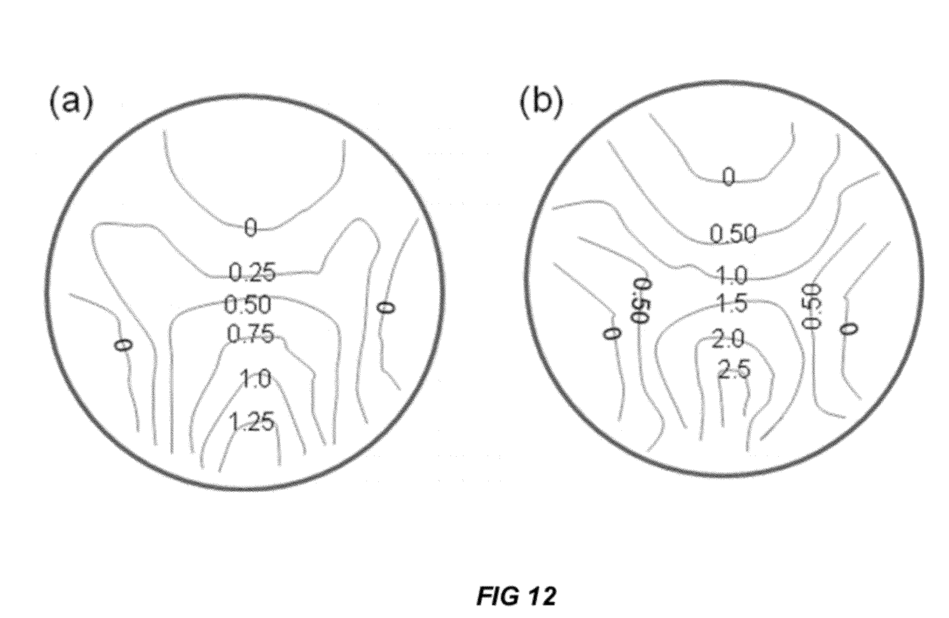

Some examples of lenses comprising the proposed LC layer (e.g. the reactive liquid crystalline coatings or “RM coatings” or that may be used in an electro-active embodiment as described above) are given, but not limited to, those in FIGS. 11(a)-(d) and FIGS. 12(a) and (b). FIGS. 11(a)-(c) present three types of lenses with refractive/power gradient.

With reference to FIG. 11(a), a lens is provided that comprises a LC layer that changes the refractive gradient of the lens from plano to 3.25 (or generally, to any other value such as from plano to 3, or plano to 2.5). That is, for instance, in some embodiments, the LC layer may comprise an optical power profile that provides substantially no optical power in region 1101 and may provide a plus optical power of 3.25 in region 1102. As was described above, this could correspond to embodiments where the LC molecules of the LC layer in region 1101 may have a pre-tilt angle that is substantially perpendicular to the substrate (e.g. based on the characteristic of an alignment layer) and the LC molecules in region 1102 may have a pre-tilt angle the is substantially parallel to the substrate. However, the particular pre-tilt angles may depend on the specific properties of the LC material, the desired optical properties of the lens region, the optical properties of the alignment layer(s), and any other components of the lens. In some embodiments, rather than the LC layer covering the entire lens surface, the LC layer may, for example, only cover the region 1102.

With reference to FIG. 11(b), a lens that has a LC layer having an optical power profile that provides the optical power needed for distance vision to full add power is shown. That is, the exemplary LC layer or layers in the region 1111 may provide the optical power needed by a wearer to see far distance objects (which may be a minus optical power). Similar to the embodiment shown in FIG. 11(a), the region 1112 of the lens may provide plus optical power that may correspond to the near distance viewing needs of the wearer. Both the optical powers provided by optical regions 1111 and 1112 may correspond to the optical power provided by the LC layer based on the pre-tilt angle of the LC molecules (which in turn may be based on the properties and features of one or more alignment layers), or may be a combination of the optical power provided by the LC layer and any other optical comments of the lens.

With reference to FIG. 11(c), a lens that comprises a LC layer having an optical power profile that may correspond to a progressive addition region is shown. That is, for instance, the exemplary lens may have a LC layer that provides an optical power that changes from far distance power in the upper part of the lens 1121, through the intermediate distance optical power in region 1122, and then the near distance optical power needed by the wearer in the central lens 1123. Some embodiments may also include a fourth optical zone corresponding to the area of the lens 1124 that may be used by the wearer to view the ground (floor) disposed in the lower part of the lens. The changes from the distance power, intermediate power, near power, and ground power, may be provided by a relatively continuous change in optical power, which may in turn be based on the continuous variation of the pre-tilt angles of the LC molecules in a LC layer. FIG. 11(d) shows an optical power profile of the exemplary lens shown in FIG. 11(c), which further illustrates the continuous change in the optical power of the LC layer (e.g. from distance optical power 1121, to intermediate optical power 1122, to near distance optical power 1123, which peaks in total add power, and then a decrease in optical power to ground optical power 1124).

It should be noted that, as described above, in some embodiments, the LC layer may have portions that may be in optical communication with other components of the lens to provide a desired optical power profile. For instance, the exemplary lens shown in FIG. 11(c) may comprise a progressive addition surface, and the LC layer may have an optical power profile (e.g. based on the pre-tilt angle of the LC molecules) that may be used to cancel or reduce the unwanted astigmatism created by the progressive surface when no field is applied across the device. When a field is applied across the device (at least for some electro-active embodiments), in some instances, the optical power profile of the LC layer may change (based on the alignment of the LC layer) so as to provide additional plus optical power to the near power optical zone 1123 and/or to any of other optical power zones (or so as to no longer provide any additional optical power).

With reference to FIGS. 12(a) and (b), two additional examples of optical power profiles of exemplary lenses are provided. In particular, FIG. 12(a) shows a lens in which the LC layer may provide a plurality of optical powers from plano near the top of the lens to a total add power of 1.25 D in increments of 0.25 D. As was described in detail above, this may be provided by altering the pre-tilt angle or orientation of the LC molecules of the LC layer, thereby changing the refractive index of portions thereof. Similarly, FIG. 12(b) shows an exemplary lens having an EL layer that has an optical profile that provides a plurality of optical powers from plano near the top of the lens to a total add power of 2.5 D in increments of 0.5 D. In general and was described above, any variety of optical power distributions may be accomplished using embodiments described, such as by using a LC layer that comprises reactive mesogen materials that differ in their molecular properties and/or by using a variety of combinations of mesogen coating methods and post-processing conditions.

### Exemplary Embodiments

Described below are further exemplary embodiments of devices such as optical devices that comprise an alignment layer that may alter the pre-tilt angle of a LC layer so as to provide lenses with a desired optical power profile (and/or or reduce unwanted astigmatism and other distortions that may be created by other optical components). The embodiments described herein are for illustration purposes only and are not thereby intended to be limiting. After reading this disclosure, it may be apparent to a person of ordinary skill in the art that various components and/or features as described below may be combined or omitted in certain embodiments, while still practicing the principles described herein.

In some embodiments, a first optical device may be provided. The first optical device may include a first substrate, a liquid crystal alignment layer comprising a controlled pattern of features each having a dimension of at most 2 microns, and a liquid crystal layer disposed adjacent to the alignment layer that includes liquid crystal molecules. The alignment layer may be disposed on the substrate, or on a component that may be disposed over the substrate (such as an electrode). The first device may include any number or combination of additional optical components or features, such as additional substrates, alignment layers, electrodes, LC layers, etc. In some embodiments, the liquid crystal alignment layer may comprise a variable liquid crystal alignment layer.

As used in this context, a “controlled pattern” may refer to when the alignment layer may have a predetermined pattern of features that are predictable and/or when the features have a controllable periodicity. That is, for instance, a controlled pattern refers to when the position, shape, and size of each feature of the alignment layer may be predetermined. The pattern need not be repeating, but may vary across the layer in accordance with the desired optical properties of the lens. This “controlled pattern” may be in contrast to a structure that occurs from traditional alignment layer fabrication methods such as rubbing (scratching), which produce random structure and patterns at dimensions typically greater than 1 or 2 microns. Examples of controlled patterns of exemplary alignment layers were described above with reference to FIGS. 4(a)-(h) and 5(a)-(c).

The use of the term “variable” in some embodiments in reference to the liquid crystal alignment layer may refer to when the alignment layer varies the pre-tilt angle of the liquid crystal molecules across at least a portion of the liquid crystal layer. Preferably, the pre-tilt angle of the liquid crystal molecules of the liquid crystal layer may vary either (1) continuously by at least 5 degrees over a distance of 1 mm or (2) discretely by at least 10 degrees over a distance of 1 mm. As used in this context, “varies the pre-tilt angle” may refer to when the pre-tilt angle of the liquid crystal molecules in one portion (or location/position) of the liquid crystal layer have a different pre-tilt angle than the liquid crystal molecules in a different portion (or location/position) of the liquid crystal layer. This does not require that all liquid crystal molecules (or the liquid crystal molecules in each portion of the liquid crystal layer) have different pre-tilt angles. For example, the alignment layer may be configured such that the pre-tilt angle of the liquid crystals varies continuously or discretely over a portion of the liquid crystal layer (e.g. from 0-90 degrees, or a smaller range). The variation in the pre-tilt angle may result in a varying refractive index profile of the liquid crystal layer (e.g. the index of refraction of the liquid crystal layer may vary based on the relative position of the liquid crystal molecule in the liquid crystal layer). The variation in pre-tilt angle may occur over the whole lens area or only on a certain portion of the lens area. Examples of alignment layers varying the pre-tilt angle of a LC layer were described above with reference to FIGS. 3, 5(a)-(c), and 10.

In some embodiments (examples of which were described above), the alignment layer may comprise a plurality of “topographical features” (i.e. anisotropic surface features) such as bumps, ridges, grooves, valleys, etc. that extend above or below the plane of the surface of the alignment layer or a substrate that the alignment layer is disposed over. It should be noted that the topographical features may have any suitable shape such as triangles, rectangles, semi-circles/ovals, etc. or even irregular shapes and combination thereof. The topographical features may have a dimension of less than approximately 2 um, but it may be preferable in some embodiments that the dimensions are less than 500 nm (and in some instances, less than 100 nm) so as to provide additional flexibility and control over the change in the pre-tilt angles and the resulting optical power provided by the liquid crystal layer. The topographical features may be regularly spaced (e.g. periodic) or irregularly spaced. The topographical structures may have any suitable form such that LC molecules adjacent to or near the topographical features have a desired pre-tilt angle. In some embodiments, the distance between each adjacent topographical feature may also be less than approximately 2 um (and preferable less than 500 nm). Other characteristics of the alignment layer and the liquid crystal layer may also affect the pre-tilt angle, such as the polarity of liquid crystal layer material, the size of liquid crystal molecules, the nature of alignment layer material, its surface energy, and/or liquid crystal layer thickness, etc.

In some embodiments, in the first optical device as described above, the liquid crystal layer may be electro-active. That is, for instance, the LC layer may be disposed between a first electrode and a second electrode such that, when a field is applied across the LC layer, the LC molecule alignments may change and thereby alter the optical properties of the LC layer. Dynamic optics may have the advantage of providing a wearer with an optical power only when needed, which may thereby allow larger portions of the lens to be used for other purposes. However, embodiments are not so limited, and in some instances, in the first optical device as described above, the liquid crystal layer may comprise reactive mesogens. As was defined above, “mesogens” may refer to the components of a liquid crystal (or similar material) that induces structural order in the crystals. Embodiments that comprise reactive mesogens may be utilized for embodiments comprising a static lens where, for instance, the LC layer may be applied to correct or adjust a static optic to a particular user's needs. The reactive mesogens may thereby be oriented (e.g. using the liquid crystal alignment layer comprising a controlled pattern of features each having a dimension of at most 2 microns) so that the liquid crystal layer has a desired optical power profile. In some embodiments, the reactive mesogens may be “reacted” so as to be frozen into place (e.g. using UV-light)

In some embodiments, in the first optical device as described above, the alignment layer may vary a pre-tilt angle of the liquid crystal molecules of the liquid crystal layer continuously by at least approximately 5 degrees over a distance of approximately 1 mm. As used in this context, “continuously varies” may refer to when the pre-tilt angle of the liquid crystal molecules varies by less than approximately 5 degrees over a distance of 10 μm. That is, if over a 10 μm distance of the LC layer, the pre-tilt angle of the liquid crystal molecules therein do not vary by more than 5 degrees, that portion of the LC layer may be considered to be continuously varying. The inventors have found that a wearer is unlikely to notice a discontinuity (such as an image jump) when looking through a lens when the pre-tilt angle of the LC molecules varies by less than 5 degrees over a 10 μm distance. Thus, it may be preferred for both aesthetics and for usability purposes that embodiments may provide this continuous change in pre-tilt angle. That is, by utilizing alignment layers and corresponding LC layers that have a continuous change in pre-tilt angle (and thereby a corresponding continuous change in optical power), a wearer is less likely to notice the transition in optical powers.

In some embodiments, the alignment layer may continuously vary the pre-tilt angle of the liquid crystal molecules over a distance of at least approximately 2 mm of the liquid crystal layer. This may correspond to, for instance, embodiments where the LC layer may be utilized to reduce an unwanted astigmatism created by a progressive addition surface. In some embodiments, the alignment layer may continuously vary the pre-tilt angle of the liquid crystal molecules over a distance of at least approximately 5 mm of the liquid crystal layer. This may correspond to some embodiments where, for instance, the LC layer may provide additional optical power (whether plus or minus) to the near, intermediate, or far distance viewing zone of a lens comprising a progressive addition surface. In some embodiments, the alignment layer may continuously vary the pre-tilt angle of the liquid crystal molecules over a distance of at least approximately 10 mm of the liquid crystal layer.

In some embodiments, the alignment layer may continuously vary the pre-tilt angle of the liquid crystal layer so as to form a progressive addition lens. That is, for instance, in some embodiments, the lens may comprise a LC layer that has an optical power profile that corresponds to a progressive addition region. In some instances, when the optical device may be electro-active, the device could comprise the progressive addition region provided by the LC layer when no field is applied (e.g. when the wearer is viewing an object at near distance); however, when the wearer would like to utilize the far distance viewing zone, an electric field could be applied across the LC layer, thereby causing the LC molecules to align themselves with the field and thereby provide a different optical power (which could be for instance, a uniform optical power and/or could be no optical power at all). It should be appreciated that the alternative may also be possible—that is, in some embodiments, the application of an electric field could cause the LC layer to provide a progressive addition region, whereas the absence of the field may remove such optical power. In this manner, any unwanted astigmatism created by a progressive addition region because of the continuous optical power may be removed when the near-distance viewing zone is not in use by the wearer

In some embodiments, in the first optical device as described above, the alignment layer may vary a pre-tilt angle of the liquid crystal molecules of the liquid crystal layer discretely by at least approximately 10 degrees over a distance of approximately 1 mm. As used herein, “discretely varies” may refer to when the pre-tilt angle of the liquid crystal molecules varies by at least approximately 5 degrees within a distance of 10 μm. Such embodiments may be used, for instance, to provide discrete optical zone for a multi-focal lens or to remove unwanted astigmatism or other distortions in a particular location on the optical device. In some embodiments, the alignment layer may vary the pre-tilt angle of the liquid crystal molecules of the liquid crystal layer discretely by at least approximately 10 degrees multiple times over a distance of approximately 1 mm. In some embodiments, the alignment layer may discretely vary the pre-tilt angle of the liquid crystal molecules at least twice over a distance of approximately 1 mm of the liquid crystal layer. The reference to “multiple times” may correspond to, for example, embodiments in which the LC layer may provide multiple optical powers in a relatively short distance (such as to cancel complex distortions created by different optical devices).

In some embodiments, in the first optical device as described above, the alignment layer may vary the pre-tilt angle of the liquid crystal molecules of the liquid crystal layer by at least approximately 10 degrees. That is, for instance, in some embodiments the difference between the liquid crystal molecules with the smallest pre-tilt angle and the liquid crystal molecules with the largest pre-tilt angle may be at least 10 degrees. Such embodiments may provide for different optical powers disposed in different locations across the LC layer. For example, a difference in pre-tilt angle of at least 10 degrees may be utilized to provide for different optical powers that may correspond, for example, to a wearer's near distance and far distance viewing optical powers. However, the exact amount of variance of the pre-tilt angle of the LC molecules in the LC layer may depend on the optical power requirements of the particular application, as well as the optical properties of the LC layer and the other optical components of the device. In some embodiments, the alignment layer may vary the pre-tilt angle of the liquid crystal molecules of the liquid crystal layer by at least approximately 20 degrees. In some embodiments, the alignment layer may vary the pre-tilt angle of the liquid crystal molecules of the liquid crystal layer by at least approximately 45 degrees. In some embodiments, the alignment layer may vary the pre-tilt angle of the liquid crystal molecules of the liquid crystal layer by approximately 90 degrees. That is, in some embodiments, the LC layer may have LC molecules in one location having a pre-tilt angle that is substantially parallel to a substrate, while in another location of the LC layer, the LC molecules may have a pre-tilt angle that is substantially perpendicular to the substrate. This may correspond to embodiments that comprise a LC layer that provides plano optical power in one location and a maximum optical power in another location (such as by providing the full add power for a near vision optical power zone).

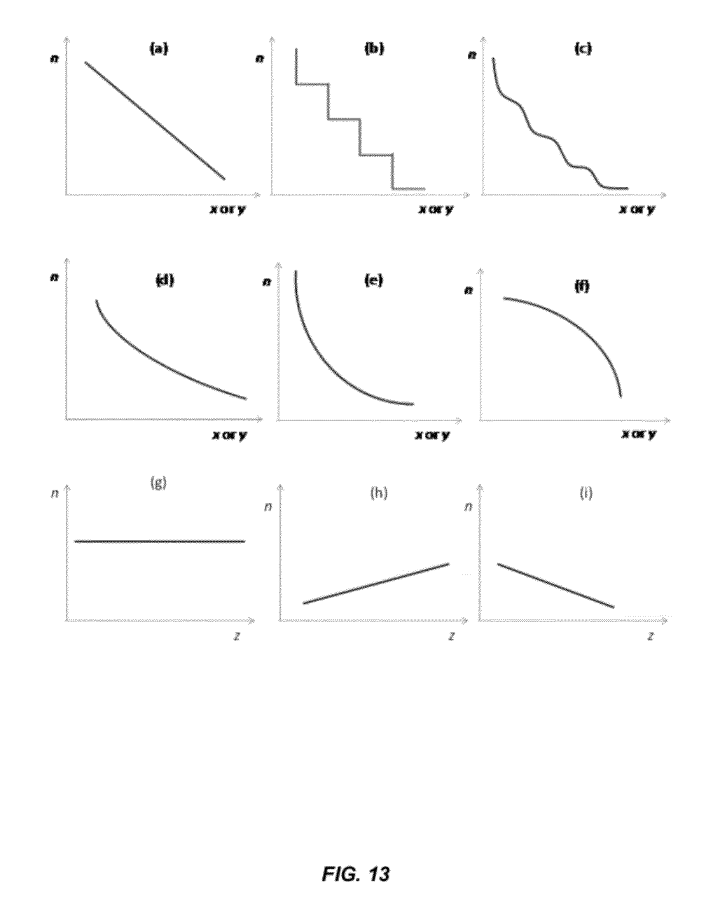

In some embodiments, in the first optical device as described above, the liquid crystal layer may have a refractive index profile, where the refractive index profile may vary at least in part based on the alignment layer. As used in this context, the “refractive index profile” of the LC layer may refer to a graph of the refractive index of the liquid crystal layer as a function of the location of liquid crystal layer (e.g. in the x-, y-, and/or z-directions). That is, for instance, the refractive index profile may refer to the index of refraction of the liquid crystal layer according to its lineal spatial coordinates along the surface of the substrate. Thus, as used in this context, a “variable refractive index profile” may refer to embodiments when the index of refraction of the LC layer may vary at different locations of the LC layer. Exemplary graphs for possible refractive index profiles of liquid crystal layers having values and directions are shown in FIGS. 13(a)-(i).

FIGS. 13(a)-(f) each show the refractive index profile of exemplary LC layers in the x- or y-direction (e.g. corresponding to a position on the surface of the LC layer) in an inactive state (e.g. when an electric field is not applied across the layer). As shown by these exemplary embodiments, in general the refractive index profile may have any shape and any value over the surface of the LC layer. It should be understood that the refractive index profile may correspond to the pre-tilt angle of the LC layer (e.g. changes in the pre-tilt angle may affect the refractive index profile of the LC layer). It should also be understood that the refractive index profile may correspond to the optical power profile of the LC layer, and thereby the characteristics of the refractive index profile may affect and/or correspond to the optical properties of the LC layer and thereby the optical properties of the device. For example, a discontinuous change in the refractive index profile over a portion of the LC layer may correspond to a discontinuous change in the optical power provided by the same portion of the LC layer.

FIG. 13(a) shows an exemplary embodiment where the index of refraction “n” of the LC layer decreases linearly as the distance along the x- or y-axis increases. FIG. 13(b) shows an embodiment in which the refractive index profile has a plurality of discontinuous changes at certain points along the x- or y-axis. This may correspond, for instance, to a multifocal lens comprising a plurality of discrete optical powers. FIGS. 13(d)-(f) each provide refractive index profiles that appear to vary continuously along the x- and y-axis; however, each is shown as having a different shape and different values and thereby may provide different optical properties across the LC layer. FIG. 13(c) shows an embodiment of a refractive index profile that may be considered between a discontinuous change in refractive power and a continuous change of refractive power. Therefore, whether a user may notice any discontinuities resulting from the corresponding changes in the optical power of the device may be based on the particular values of the embodiments. FIGS. 13(g)-(i) illustrate the concept that the refractive index profile (and thereby the pre-tilt angle of the LC molecules) of the LC layer may vary along the z-axis (e.g. the thickness of the LC layer may affect the optical properties of portions of the LC layer). This may result, for instance, because in some embodiments the portions of the LC layer that may be disposed at a distance farther away from the alignment layer may be less affected by the properties of the alignment layer. This is illustrated in the exemplary refractive power profile shown in FIG. 13(i), where, assuming that the alignment layer is disposed at z=0 (e.g. on the back surface of the LC layer), the refractive index is shown as decreasing as the distance from the alignment layer increases. FIG. 13(h) may represent an alternative embodiment, in which the alignment layer may be disposed at a positive location of z (e.g. on the front surface of the LC layer), and thereby the refractive power increases as the position z increases (e.g. as the portion of the LC layer gets closer to the alignment layer). FIG. 13(g) may correspond to embodiments where the refractive index of the LC layer may be relatively constant, such as, for example, when the thickness of the LC layer is relatively small (or the force of the alignment layer is relatively strong), when there is an alignment layer located on both surfaces of the LC layer, and/or when an electric field is applied across the LC layer such that the LC molecules may substantially align. As noted above, each of these exemplary refractive index profiles is provided for illustration purposes only, and embodiments are not intended to be limited thereto.

In some embodiments, the refractive index profile of the liquid crystal layer may vary by at least approximately 0.2. That is, for instance, in some embodiments the difference between the portion of the liquid crystal layer with the smallest index of refraction and the portion of the liquid crystal layer with the largest index of refraction may be at least approximately 0.2 (but preferable at least 0.17). For instance, a typical liquid crystal used in some embodiments may have an ordinary refractive index of 1.50 and extraordinary refractive index of 1.85, aligned on the liquid crystal alignment layer, where certain surface nano-features generate no pre-tilt angle in some locations, and other surface nano-features generate 90° pre-tilt in other locations, will result in liquid crystal layer with a refractive index profile varying from 1.50 to 1.675. However, other refractive index profiles are possible, and may depend on the characteristics of the LC layer.

In this regard, some embodiments, the refractive index profile of the liquid crystal layer may vary by at least approximately 0.05. In some embodiments, the refractive index profile of the liquid crystal layer may vary by at least approximately 0.2. In some embodiments, the refractive index profile may vary continuously for at least a portion of the liquid crystal layer. As used in this context, “continuously varies” may refer to when the refractive index of the liquid crystal layer varies by less than approximately 0.1 within a distance of 1 mm. In some embodiments, the refractive index profile may vary discretely for at least a portion of the liquid crystal layer. As used in this context, “discretely varies” may refer to when the refractive index of the liquid crystal layer varies by approximately 0.1 or greater within a distance of 1 mm.

In some embodiments, in the first optical device as described above, the liquid crystal layer may have a first optical power profile when a field (e.g. an electric field) is not applied across the liquid crystal layer, where the first optical power profile varies at least in part based on the alignment layer. As used in this context, the “optical power profile” of the liquid crystal layer may refer to a graph of the optical power of the liquid crystal layer as a function of the location of liquid crystal layer (e.g. in the x-, y-, and/or z-directions). That is, for instance, the optical power profile may refer to the optical power of the liquid crystal layer according to its linear spatial coordinates along the surface of the substrate. A “variable” optical power profile may thereby refer to when the optical power of the LC layer may be different at different locations of the LC layer.

In general, the embodiment described above may correspond to both electro-active devices and devices that comprise reactive mesogens. That is, for instance, the reactive mesogens embodiments may have the same optical power profile whether a field is applied across the LC layer or not. The electro-active layer embodiments may have a first optical profile when an electric field is not applied across the LC layer and a second optical power profile when an electric field is applied over at least part of the LC layer. In some embodiments, the first optical power profile of the liquid crystal layer may vary by at least approximately 0.2 diopters. In some embodiments, the first optical power profile of the liquid crystal layer may vary by at least approximately 0.5 diopters. In some embodiments, the first optical power profile of the LC layer may vary by at least approximately 1.0 diopter. In some embodiments, the first optical power profile of the liquid crystal layer may vary by at least approximately 1.5 diopters. In some embodiments, the first optical power profile of the liquid crystal layer may vary between approximately 0.25 to 4.0 diopters. As was described above, the LC layer may generally provide any suitable optical power required by a wearer. The optical power may, for instance, correspond to a near distance, intermediate distance, and/or far distance viewing optical power. The optical power may be based at least in part, on the pre-tilt angle of the LC molecules of the LC layer. The pre-tilt angle may be dictated, at least in part, by the topographical features that may be disposed on the alignment layer adjacent to the LC layer.

In some embodiments, in the first optical device as described above where the liquid crystal layer may have a first optical power profile when a field (e.g. an electric field) is not applied across the liquid crystal layer, where the optical power profile may vary continuously for at least a portion of the liquid crystal layer. As used in this context, “continuously varies” may refer to when the optical power of the liquid crystal layer varies by less than approximately 0.1 D within a distance of 1 mm. In some embodiments, the first optical power profile may vary discretely for at least a portion of the liquid crystal layer. As used in this context, “discretely varies” may refer to when the optical power of the liquid crystal layer varies by approximately 0.1 D or greater within a distance of 1 mm.

In some embodiments, in the first optical device as described above, the liquid crystal layer may comprise anyone of, or some combination of, nematic, smectic, or cholesteric liquid crystals.

In some embodiments, in the first optical device as described above, the alignment layer may comprise polyimide, polyvinyl alcohol, polyacrylate, polymethacrylate, polyurethane and/or epoxy material.

In some embodiments, in the first optical device as described above, the alignment layer may include a plurality of topographical features, where each topographical feature may have an approximate geometric center. The approximate geometric center of each topographical feature may be located at a distance d₂ from the center of an adjacent topographical feature. In some embodiments, the distance d₂ between each adjacent topographical feature may be approximately the same. Exemplary embodiments were described above with reference to FIGS. 4(a)-(h). This may, for instance, provide a portion of the LC layer that has LC molecules having substantially uniform pre-tilt angles. In some embodiments, the distance d₂ between each adjacent topographical feature may vary across the alignment layer. This may provide a LC layer having a variable optical property based on, for instance, the variation of the pre-tilt angles of the LC molecules across the LC layer. In some embodiments, the distance d₂ between the approximate geographic centers of each adjacent topographical feature may be between approximately 10 and 200 nm. In some embodiments, the first substrate has an approximate geometric center and the distance d₂ between the approximate geographic centers of each adjacent topographical feature is smaller for topographical features that are disposed closer to the center of the first substrate. This may result, for instance, in the pre-tilt angle of the LC molecules closer to the center of the first substrate being larger than those that are located farther away. However, embodiments are not so limited and, depending for instance on the geometry of the topographical features, some embodiments of a nano-structure alignment layer may have a different effect, such as where the grater the distance between the optical features, the larger the pre-tilt angle.

In some embodiments, in the first optical device as described above, the alignment layer may comprise a plurality of topographical features. In some embodiments, each topographical feature of the alignment layer may have a height d₃, where the height d₃ of each of the topographical features may be approximately the same. As used herein, the “height” of a topographical feature of the alignment layer may refer to the distance of the topographical feature that extends above the surface of the alignment layer and/or the surface of a substrate that the alignment layer may be disposed over. Exemplary embodiments showing the “height” of a topographical feature of an alignment layer are shown in FIGS. 4(a)-(h).

In some embodiments, in the first optical device as described above, the alignment layer may comprise a plurality of topographical features. In some embodiments, each topographical feature may have a height d₃, where the height d₃ of the topographical features may vary across the liquid crystal layer. In some embodiments, the height d₃ of each topographical feature may be between approximately 10 and 200 nm.

In some embodiments, in the first optical device as described above, the liquid crystal layer may be disposed over an entire surface of the first substrate. Exemplary embodiments are shown in FIGS. 1(a) and 2(a) and described above. In some embodiments, in the first device as described above, the liquid crystal layer may be disposed over a portion of a surface of the first substrate. Exemplary embodiments were described above with reference to FIGS. 1(b) and 2(b).

In some embodiments, in the first optical device as described above, the alignment layer may be disposed over an entire surface of the first substrate. In some embodiments, in the first device as described above, the alignment layer may be disposed over a portion of a surface of the first substrate. In general, the alignment layer may be disposed over substantially the same portions of the substrate as the LC layer, but this need not be the case. In some embodiments, the alignment layer may be disposed only over portions of the substrate having a corresponding portion of the LC layer for which an optical property or feature is required or desired.

In some embodiments, in the first optical device as described above, the first optical device may comprise a semi-finished or finished lens blank. The optical device may generally comprise any ophthalmic device or components thereof. For some embodiments that comprise a semi-finished lens blank, the lens blank may be finished based on the specific needs of the patient. In turn, the characteristics of the alignment layer (such as the liquid crystal alignment layer described above) may also be customized based on the wearer's need. In some embodiments, the first device may comprise an optical feature disposed on the surface of a substrate (such as a progressive addition lens). A LC layer may then be applied (unless already disposed on the optical device) so as to be in optical communication with portions of the optical feature. The LC layer may then be altered (e.g. by changing the orientation of the LC molecules) so that the LC layer has optical properties that may customize the optical device for each user. For example, a wearer may require a particularly strong near distance optical power. The base substrate of the optical device may be mass produced and provide a full-add power of a progressive addition region that is 1.0 D less than the need of the patient. Rather than having to provide an entire new substrate, embodiments may utilize a LC layer disposed in optical communication with the add power zone of the progressive addition region. Using any of the suitable method such as those described above (particularly with regard to the reactive mesogen embodiments), the LC layer may have its optical properties adjusted so as to add 1.0 D of plus add power to the near distance optical zone of the progressive addition region. Such exemplary methods may reduce costs and manufacturing time because, for instance, a plurality of complex surfaces may be pre-fabricated on lens blanks and a thin LC layer may be applied thereafter so as to customize each of the optical devices for its intended purpose

In some embodiments, in the first optical device as described above, the first optical device may further include a second substrate, a first electrode, and a second electrode, where the first and the second electrode may be disposed between the first substrate and the second substrate. The alignment layer and the liquid crystal layer may be disposed between the first electrode and the second electrode. In this manner, some embodiments of the liquid crystal layer may be electro-active. In some embodiments, the first optical device may further include a second liquid crystal alignment layer comprising a controlled pattern of features having a dimension of at most approximately 2 microns. That is, some embodiments may comprise a plurality of alignment layers that may be disposed, for instance on either side of the liquid crystal layer. For instance, in some embodiments, the second alignment layer may be disposed on a surface of the second substrate. In some embodiments, the second alignment layer may be disposed between the first electrode and the second electrode. In some embodiments, the second liquid crystal alignment layer may comprise a variable liquid crystal alignment layer.

In some embodiments, in the first optical device as described above, the optical device may include a first optical zone. The first optical zone may be in optical communication with a first portion of the alignment layer, a first portion of the liquid crystal layer, and a first portion of the first substrate. The first optical zone may have an optical power that comprises the optical power provided by the first portions of the alignment layer, the liquid crystal layer, and the first substrate. That is, each of these portions of the components of the device may be in optical communication such that, at least in the first region, the optical feature or features of these components may be added together to determine the total optical power of the device in that optical region. In this way, one or more components may be used to provide additional plus or minus add power, or may even serve to reduce or cancel the optical features of another layer or component, such as if one layer creates an unwanted astigmatism.

In some embodiments, the optical power of the first portion of the liquid crystal layer (i.e. a portion of the LC layer that is in optical communication first optical zone) when an electric field is not applied may comprise a progressive optical power. In some embodiments, where the optical power of the first portion of the liquid crystal layer when an electric field is not applied comprises a progressive optical power, the progressive optical power may provide a full add power of at least 0.5 D. In some embodiments, where the optical power of the first portion of the liquid crystal layer when an electric field is not applied comprises a progressive optical power, the progressive optical power may provide a full add power of at least 1.0 D. In some embodiments, where the optical power of the first portion of the liquid crystal layer when an electric field is not applied comprises a progressive optical power, the progressive optical power may provide a full add power of at least 1.5 D. In general, the LC layer may provide any suitable feature, including a progressive addition region, having a full optical add power needed by a wearer's prescription. As noted above, reference to “when no electric field is applied” does not require that the optical properties of the LC layer change when an electric field is applied. Indeed, embodiments comprising a progressive addition region may comprise electro-active or static embodiments.

In some embodiments, in first optical device as described above where the optical power of the first portion of the liquid crystal layer when an electric field is not applied comprises a progressive optical power, the optical power of the first portion of the first substrate is a negative optical power. This could provide, for instance a far distance vision correction required by the wearer.

In some embodiments, in the first optical device as described above, the first optical device may further include a progressive addition surface. In some embodiments, the progressive addition surface may be disposed on the first substrate. In some embodiments, the progressive addition surface may create an unwanted astigmatism. A portion of the liquid crystal layer (which may be in optical communication with the unwanted astigmatism) may have an optical power such that the unwanted astigmatism is at least partially reduced when a field is not applied across the liquid crystal layer. In some embodiments, the portion of the liquid crystal layer may have an optical power such that the unwanted astigmatism is reduced by at least approximately 30% when a field is not applied across the liquid crystal layer. In some embodiments, the portion of the liquid crystal layer may have an optical power such that the astigmatism is removed when a field is not applied across the portion of liquid crystal layer.

In some embodiments, in the first optical device as described above that includes a progressive addition surface and a portion of the liquid crystal layer that has an optical power such that the unwanted astigmatism is at least partially reduced, the first optical device may include a first optical zone. The progressive addition surface may provide a plus optical power to the first optical zone; the liquid crystal layer may also provide plus optical power to the first optical zone when a field is applied to the liquid crystal layer. That is, for instance, the LC layer may be designed such that, when a field is applied across the layer, the LC layer provides additional optical power as needed. This may reduce the requirements of the optical power needed by the static components of the optical device, which may reduce any unwanted distortion or astigmatism (which generally increases with a greater continuous optical power change and/or greater optical power discontinuity). In some embodiments, the liquid crystal layer may provide at least approximately 0.5 D of plus optical power to the first optical zone when a field is applied to the liquid crystal layer. In some embodiments, the liquid crystal layer may provide at least approximately 1.0 D of plus optical power to the first optical zone when a field is applied to the liquid crystal layer. In some embodiments, the liquid crystal layer may provide at least approximately 1.5 D of plus optical power to the first optical zone when a field is applied to the liquid crystal layer.

In some embodiments, in the first optical device as described above that includes a progressive addition surface and a portion of the liquid crystal layer that has an optical power such that the unwanted astigmatism is at least partially reduced, where the progressive addition surface may provide a plus optical power to a first optical zone and where the liquid crystal layer may provide plus optical power to the first optical zone when a field is applied to the liquid crystal layer, the liquid crystal layer mal also provide a minus optical power to the first optical zone when a field is not applied to the liquid crystal layer. In this manner, the LC layer may also provide or contribute to the far distance viewing optical power needed by a wearer when the device is in an inactive state.

In some embodiments, in the first optical device as described above, the liquid crystal layer may provide a progressive optical power when a field is not applied across the liquid crystal layer and a uniform optical power when a field is applied across the liquid crystal layer.

In some embodiments, in the first optical device as described above, the liquid crystal layer may comprise a substantially uniform material. The use of the term “substantially uniform material,” may refer to when a layer comprises approximately the same material at any two locations (e.g. within experimental error and/or manufacturing error). That is, for example, the material at any two locations may comprise the same materials in the same concentrations to within approximately 5%.

In some embodiments, in the first optical device as described above, the liquid crystal layer has a thickness that is less than approximately 100 nm. In some embodiments, in the first optical device as described above, the liquid crystal layer may have a thickness that is between approximately 50 nm and 100 nm. In some embodiments, in the first optical device as described above, the first optical device may comprise an ophthalmic lens.

In some embodiments, a first method of may be provided. The first method may include the steps of providing a substrate having a liquid crystal layer that comprises reactive mesogens and controlling an alignment of the reactive mesogens in the liquid crystal layer. The alignment may be controlled by utilizing a liquid crystal alignment layer having a controlled pattern of features. The features may have a dimension of at most 2 microns. The liquid crystal alignment layer may comprise a variable liquid crystal alignment layer. The first method may further include the step of solidifying the reactive mesogens in the alignment.

As used herein, “controlling an alignment” of the reactive mesogens may further include using additional methods to control the orientation of the LC molecules of the LC layer (i.e. other than the use of an alignment layer), such as by using a photo-aligned layer, a rubber layer on the substrate adjacent to the liquid crystal layer, exposing different portion of the liquid crystal layer to different intensities/amounts of UV radiation, utilizing a liquid crystal photoiniator and/or polarized UV light, as well as local heating, or any other suitable method including the examples provided above.

As used herein, “solidifying the reactive mesogens” may include any suitable manner of freezing or holding the reactive mesogens in an alignment (i.e. having a pre-tilt angle). That is, for example, solidifying may refer to when the reactive mesogens are reacted so that they maintain an alignment or orientation (i.e. a pre-tilt angle).

In some embodiments, in the first method as described above, the step of solidifying the reactive mesogens may comprise UV irradiation. In some embodiments, the UV irradiation may comprise unpolarized UV light having a wavelength between approximately 300 and 400 nm.

In some embodiments, in the first method as described above, the step of controlling the alignment layer may include disposing a second alignment layer adjacent to the liquid crystal layer. An example of this embodiment is shown in FIG. 14 and described above. In some embodiments, the second alignment layer may comprise a controlled pattern of features each having a dimension of at most 2 microns. However, embodiments are not so limited, and the second alignment layer may comprise any suitable properties so as to adjust the pre-tilt angle of the LC layer.

In some embodiments, in the first method as described above, the step of controlling the alignment layer may further include processing the mesogens with a variable UV light beam. In some embodiments, processing the mesogens with a variable UV light beam may comprise varying the UV exposure of the mesogens. In some embodiments, varying the UV exposure may comprise varying the intensity of the UV light beam. As used in this context, “varying the intensity of the UV light beam” may refer to a process where the UV light beam may have a varying (i.e. different) intensity when different portions of the liquid crystal layer are exposed to the UV light beam. In some embodiments, the intensity of the UV light beam may be varied by at least approximately 5%. For example, if the intensity of the UV light beam varies by 5%, this may refer to a processes in which the intensity of the UV light when one portion of the liquid crystal layer was exposed to the UV radiation was 5% higher or lower than the intensity of the UV light when at least one other portion of the liquid crystal layer was exposed. In some embodiments, the intensity of the UV light beam may be varied by at least approximately 10%. In some embodiments, the intensity of the UV light beam may be varied by at least approximately 30%. In some embodiments, the intensity of the UV light beam may be varied by at least approximately 50%. In general, the greater the variation of the UV light beam, the greater the deviation of the pre-tilt angle of the LC layer.

In some embodiments, the step of varying the UV exposure of the mesogens may comprise exposing different portions of the liquid crystal layer to the UV beam for different amounts of time. This may have the same or similar effect to exposing different portions of the LC layer to higher intensity UV radiation for the same amount of time. In some embodiments, the amount of time different portions of the liquid crystal layer may vary by at least approximately 10%. In some embodiments, the amount of time different portions of the liquid crystal layer may vary by at least approximately 20%. In some embodiments, the amount of time different portions of the liquid crystal layer may vary by at least approximately 50%.

In some embodiments, in the first method as described above, the liquid crystal layer may have a refractive index profile that is based in part on the alignment layer. As was noted above, a “refractive index profile” refers to the refractive index of the liquid crystal layer in the x-, y-, and z-directions. That is, for instance, the refractive index profile refers to the index of refraction of the layer according to its lineal spatial coordinate along the surface of the substrate. A “variable” refractive index profile may refer to when the index of refraction of the layer is different at different locations of the liquid crystal layer. Examples of exemplary refractive index profiles were described above with reference to FIGS. 13(a)-(i). In some embodiments, the refractive index profile may vary continuously.

In some embodiments, in the first method as described above, the alignment layer may comprise a surface topography; where the refractive index profile may vary based at least in part on the surface topography of the alignment layer

In some embodiments, in the first method as described above, the liquid crystal layer may be substantially continuous. As used herein, “substantially continuous” may refer to when the alignment layer is not segmented or separated by a barrier or other component. Thus, for instance, while the liquid crystal layer need not cover the entire surface of the substrate, there may be no portion of the liquid crystal layer that is not connected to another portion of the liquid crystal layer.

In some embodiments, in the first method as described above, the liquid crystal layer may have a thickness that is less than approximately 100 nm. In some embodiments, the liquid crystal layer may have a thickness that is between approximately 50 nm and 100 nm.

### CONCLUSION

It is understood that the various embodiments described herein are by way of example only, and are not intended to limit the scope of the invention. For example, many of the materials and structures described herein may be substituted with other materials and structures without deviating from the spirit of the invention. The present invention as claimed may therefore includes variations from the particular examples and preferred embodiments described herein, as will be apparent to one of skill in the art. It is understood that various theories as to why the invention works are not intended to be limiting.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

Although many embodiments were described above as comprising different features and/or combination of features, a person of ordinary skill in the art after reading this disclosure may understand that in some instances, one or more of these components could be combined with any of the components or features described above. That is, one or more features from any embodiment can be combined with one or more features of any other embodiment without departing from the scope of the invention.

As noted previously, all measurements, dimensions, and materials provided herein within the specification or within the figures are by way of example only.

A recitation of “a,” “an,” or “the” is intended to mean “one or more” unless specifically indicated to the contrary.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

1.-86. (canceled)

87. An optical device comprising:
a first substrate;
a liquid crystal alignment layer comprising a controlled pattern of features each having a dimension of at most 2 microns; and
a liquid crystal layer disposed adjacent to the alignment layer, wherein the liquid crystal layer comprises liquid crystal molecules.

88. The optical device of claim 87, wherein the liquid crystal alignment layer is a variable liquid crystal alignment layer.

89. The optical device of claim 87, wherein the liquid crystal layer is electro-active.

90. The optical device of claim 87, wherein the liquid crystal layer comprises reactive mesogens.

91. The optical device of claim 87, wherein the alignment layer varies a pre-tilt angle of the liquid crystal molecules of the liquid crystal layer continuously by at least 5 degrees over a 1 mm distance.

92. The optical device of claim 87, wherein the alignment layer varies a pre-tilt angle of the liquid crystal molecules of the liquid crystal layer discretely by at least 10 degrees over a distance of 1 mm.

93. The optical device of claim 92, wherein the alignment layer varies a pre-tilt angle of the liquid crystal molecules of the liquid crystal layer discretely by at least 10 degrees multiple times over a distance of 1 mm.

94. The optical device of claim 87, wherein the alignment layer varies the pre-tilt angle of the liquid crystal molecules of the liquid crystal layer by at least approximately 45 degrees.

95. The optical device of claim 87,
wherein the liquid crystal layer has a refractive index profile; and
wherein the refractive index profile varies at least in part based on the alignment layer.

96. The optical device of claim 87,
wherein the liquid crystal layer has a first optical power profile when a field is not applied across the liquid crystal layer; and
wherein the first optical power profile varies at least in part based on the alignment layer.

97. The optical device of claim 87, wherein the liquid crystal layer comprises nematic, smectic, or cholesteric liquid crystals.

98. The optical device of claim 87, wherein the alignment layer comprises polyimide, polyvinyl alcohol, polyacrylate, polymethacrylate, polyurethane or epoxy material.

99. The optical device of claim 87,
wherein the alignment layer comprises a plurality of topographical features;
wherein each topographical feature has an approximate geometric center;
wherein the approximate geometric center of each topographical feature is located at a distance d₂ from the center of an adjacent topographical feature; and
wherein the distance d₂ between each adjacent topographical feature is approximately the same.

100. The optical device of claim 87,
wherein the alignment layer comprises a plurality of topographical features;
wherein each topographical feature has an approximate geometric center;
wherein the approximate geographic center of each topographical feature is located at a distance d₂ from the center of an adjacent topographical feature; and
wherein the distance d₂ between each adjacent topographical features varies across the alignment layer.

101. The optical device of claim 100, wherein the distance d₂ between the approximate geographic centers of each adjacent topographical feature is between approximately 10 and 200 nm.

102. The optical device of claim 100,
wherein the first substrate has an approximate geometric center; and
wherein the distance d₂ between the approximate geographic centers of each adjacent topographical feature is smaller for topographical features that are disposed closer to the center of the first substrate.

103. The optical device of claim 87, further comprising:
wherein the alignment layer comprises a plurality of topographical features;
wherein each topographical feature of the alignment layer has a height d₃; and
wherein the height d₃ of each of the topographical features is approximately the same.

104. The optical device of claim 87, further comprising:
wherein the alignment layer comprises a plurality of topographical features;
wherein each topographical feature has a height d₃; and
wherein the height d₃ of the topographical features varies across the liquid crystal layer.

105. The optical device of claim 104, wherein the height d₃ of each topographical feature is between approximately 10 and 200 nm.

106. The optical device of claim 87, further comprising:
a second substrate;
a first electrode and a second electrode;
wherein the first electrode and the second electrode are disposed between the first substrate and the second substrate;
wherein the alignment layer and the liquid crystal layer are disposed between the first electrode and the second electrode; and
wherein the liquid crystal layer is electro-active.

107. The optical device of claim 87,
wherein the optical device comprises a first optical zone;
wherein the first optical zone is in optical communication with a first portion of the alignment layer, a first portion of the liquid crystal layer, and a first portion of the first substrate; and
wherein the first optical zone has an optical power that comprises the optical power provided by the first portions of the alignment layer, the liquid crystal layer, and the first substrate.

108. The optical device of claim 107, wherein the optical power of the first portion of the liquid crystal layer when an electric field is not applied is a progressive optical power.

109. The optical device of claim 87, further comprising a progressive addition surface.

110. The optical device of claim 109, wherein the progressive addition surface creates an unwanted astigmatism; and
wherein a portion of the liquid crystal layer has an optical power such that the unwanted astigmatism is at least partially reduced when a field is not applied across the liquid crystal layer.

111. The optical device of claim 110,
wherein the optical device comprises a first optical zone;
wherein the progressive addition surface provides a plus optical power to the first optical zone; and
wherein the liquid crystal layer provides plus optical power to the first optical zone when a field is applied to the liquid crystal layer.

112. The optical device of claim 107,
wherein the liquid crystal layer provides a progressive optical power when a field is not applied across the liquid crystal layer; and
wherein the liquid crystal layer provides a uniform optical power when a field is applied across the liquid crystal layer.

113. The optical device of claim 87, wherein the optical device comprises an ophthalmic lens.

114. A first method comprising:
providing a substrate having a liquid crystal layer that comprises reactive mesogens;
controlling an alignment of the reactive mesogens in the liquid crystal layer by utilizing a liquid crystal alignment layer comprising a controlled pattern of features having a dimension of at most 2 microns; and
solidifying the reactive mesogens in the alignment.

115. The method of claim 114, wherein controlling the alignment layer further comprises processing the mesogens with a variable UV light beam.

116. The method of claim 115, wherein processing the mesogens with a variable UV light beam comprises varying the UV exposure of the mesogens.

117. The method of claim 116, wherein varying the UV exposure comprises varying the intensity of the UV light beam.

118. The method of claim 116, wherein varying the UV exposure of the mesogens comprises exposing different portions of the liquid crystal layer to the UV beam for different amounts of time.

119. The method of claim 114, wherein controlling the alignment layer further comprises a combination of processing the mesogens with a variable UV light beam and local heating.
